(19) United States
(12) Patent Application Publication
(10) Pub. No.: US 2026/0301737 A1
(43) Pub. Date: Oct. 1, 2026

(54) DIALOG CONTEXT FOR GENERATIVE MODEL PROCESSING

(71) Applicant: Amazon Technologies, Inc., Seattle, WA (US)

(72) Inventors: Ravi Kumar Herunde Prakash, Lake Forest, CA (US); Austin Jia-Enn Liou, Lake Forest, CA (US); Genna Michelle Krecicki Moderhack, Washington, DC (US); Adam Marek Gabrys, Santa Clara, CA (US); Liang Wen, Huntington Beach, CA (US)

(21) Appl. No.: 19/093,996

(22) Filed: Mar. 28, 2025

(51) Int. Cl. G10L 15/183; G10L 15/22

(52) U.S. Cl. CPC G10L 15/183; G10L 15/22

(57) ABSTRACT

Techniques for enabling a user to resume a user-system dialog, without the user explicitly requesting resumption of the dialog, are described. The system may determine the semantic similarity of a received user input to user-system dialogs involving the user. If the system determines the user input is not semantically similar to any stored dialogs, the system may process the user input without using a dialog as context. Conversely, if the system determines the user input is semantically similar to a stored dialog, the system may use the semantically similar dialog as context when processing the user input. If the system determines the user input is semantically similar to more than one stored dialog, the system may request the user select one of the semantically similar dialogs to be used as context when processing the user input.

### BACKGROUND

Natural language processing systems have progressed to the point where humans can interact with computing devices using their voices and natural language textual input. Such systems employ computing techniques to identify words spoken and written by a human user based on the various qualities of received input data. Speech recognition combined with natural language understanding processing techniques enable speech-based user control of computing devices to perform tasks based on the user's spoken or other natural language inputs. Such processing may be used by computers, hand-held devices, telephone computer systems, kiosks, and a wide variety of other devices to improve human-computer interactions.

### BRIEF DESCRIPTION OF DRAWINGS

FIG. 1 is a conceptual diagram illustrating a system for determining a dialog for use as context when processing a user input, according to embodiments of the present disclosure.

FIG. 2 is a process flow diagram of an example method performable by a dialog component, according to embodiments of the present disclosure.

FIG. 3 is a conceptual diagram illustrating how dialog summary (embedding) data may be generated and stored, according to embodiments of the present disclosure.

FIG. 4 is a conceptual diagram illustrating how a dialog summary may be updated, according to embodiments of the present disclosure.

FIG. 5 is a conceptual diagram illustrating how a semantic similarity threshold value can be determined, according to embodiments of the present disclosure.

FIG. 6 is a conceptual diagram illustrating example components of a system configured to use a language model to determine a response to a user input, according to embodiments of the present disclosure.

FIG. 7 is a conceptual diagram illustrating example processing of the system configured to use a language model, according to embodiments of the present disclosure.

FIG. 8 is a conceptual diagram illustrating example components of the system, according to embodiments of the present disclosure.

FIG. 9 is a block diagram conceptually illustrating example components of a device, according to embodiments of the present disclosure.

FIG. 10 is a block diagram conceptually illustrating example components of a system, according to embodiments of the present disclosure.

FIG. 11 illustrates an example of a network for use with the overall system, according to embodiments of the present disclosure.

### DETAILED DESCRIPTION

Natural language processing (NLP) is a field of computer science, artificial intelligence, and linguistics concerned with processing a user command input in the form of a natural human language (e.g., English, German, Chinese, etc.). Such a natural language command may come in the form of audio, text, image, or other format. Natural language processing may involve a number of different specific processing techniques such as those discussed below. Automatic speech recognition (ASR) is a field of computer science, artificial intelligence, and linguistics concerned with transforming audio data associated with speech into a textual or other token representation of that speech. Similarly, natural language understanding (NLU) is a field of computer science, artificial intelligence, and linguistics concerned with enabling computers to derive meaning from natural language inputs (such as spoken inputs). ASR and NLU are often used together as part of a language processing component of a system, and a single component can be used to input audio and output a natural language understanding of any speech in the audio. Synthesized speech generation (SSG) (including text-to-speech (TTS)) is a field of computer science concerning transforming textual and/or other data into audio data that is synthesized to resemble human speech. Natural language generation (NLG) is a field of artificial intelligence concerned with automatically transforming data into natural language (e.g., English) content. Speech-to-speech (S2S) is a field of computer science, artificial intelligence, and linguistics in which embedding data is generated to represent speech in audio data and, using one or more models, the embedding data is processed to generate audio data and/or a system command (such as an application programming interface (API) call) responsive to the speech. Language modeling (LM) is the use of various statistical and probabilistic techniques to determine the probability of a given sequence of words occurring in a sentence. LM can be used to perform various tasks including understanding a natural language input and performing generative tasks that involve generating natural language output data.

Certain systems may be configured to respond to natural language (e.g., spoken or typed) user inputs. For example, in response to the user input “what is today's weather,” the system may output weather information for the user's geographic location. As another example, in response to the user input “what are today's top stories,” the system may output one or more news stories. For further example, in response to the user input “tell me a joke,” the system may output a joke to the user.

A system may receive a user input as speech. For example, a user may speak an input to a device. The device may send audio data, representing the spoken input, to the system. The system may perform ASR processing on the audio data to generate ASR data (e.g., text data, token data, etc.) representing the user input. The system may perform processing on the ASR data to determine an action responsive to the user input. A system may also receive a natural language user input in the form of text, such as a text input from a computer, phone, or other device. Alternatively, or in addition, the device itself may perform all or a portion of such processing.

In some instances, the system may be configured to process input text data (such as ASR data or text entered into a user interface or extracted from an image using optical character recognition) using one or more language models (e.g., one or more large language models (LLMs)) to determine a response to the user input. For example, in response to a user input of “what is the history of the United States,” the language model(s) may output a synopsis of the history of the United States of America.

An artificial intelligence (AI) system may use ASR, NLU, NLG, and/or TTS, each with and/or without its own and/or a shared language model, for processing user inputs, including natural language inputs (e.g., typed, displayed, and spoken inputs) and other type of inputs (e.g., inputs not received from a user, inputs received from a system component, inputs representing occurrence of events, etc.).

The AI system may use other types of generative models including a model that processes audio (such as speech and/or non-speech sounds) as an input and outputs audio (e.g., synthesized speech generated by a speech-to-speech model). Another example generative model that may be used is a multi-modal model that processes two or more types of data (e.g., audio, text and/or image) as inputs and/or outputs two or more types of data (e.g., audio, text and/or image).

Teachings of the present disclosure provide, among other things, improved processing for generative models (e.g., language models) by increasing the likelihood that context provided in the prompt to the generative model will be relevant to the generative model's processing. The techniques described herein can improve the accuracy of generative model outputs.

A user may engage a system in a dialog, which may involve communication between a computing system and a human via text, audio, and/or other forms of communication. While some dialogs involve only simple generation of a response given only a most recent input from a user (i.e., single-turn dialog), more complicated dialogs may involve determining and optionally acting on one or more goals expressed by the user over multiple turns, such as making a restaurant reservation and/or booking an airline ticket. It is beneficial for multi-turn, “goal-oriented” dialog systems to recognize, retain, and use information collected during more than one input during a “multi-turn” interaction with the user.

As used herein, a “dialog” may refer to multiple related user inputs and system outputs [e.g., through user device(s)] between the system and the user that may have originated with a single user input initiating the dialog. Thus, the data associated with a dialog may be associated with a same dialog identifier, which may be used by components of the system to associate information across the dialog. Subsequent user inputs of the same dialog may or may not start with the user speaking a wakeword. Each natural language input may be associated with a different natural language input identifier, and each natural language input identifier may be associated with a corresponding dialog identifier. Further, other non-natural language inputs (e.g., image data, gestures, button presses, etc.) may relate to a particular dialog depending on the context of the inputs. For example, a user may open a dialog with a system with a spoken utterance requesting a food delivery, the system may respond by displaying images of food available for order, and the user may speak a response (e.g., “item 1” or “that one”) or may gesture a response (e.g., point to an item on the screen or give a thumbs-up) or may touch the screen on the desired item to be selected. Non-speech inputs (e.g., gestures, screen touches, etc.) may be part of the dialog and the data associated therewith may be associated with the dialog identifier of the dialog.

Teachings of the present disclosure enable a user to resume a dialog with a system without the user needing to explicitly request resumption of the dialog and based on determining that a user input from a user relates to the dialog, supporting a more natural way of interacting with the system. Moreover, the system is configured to enable the user to resume the dialog using a device different from that used previously for the same dialog.

When the system receives a user input, the system may determine an embedding of the user input, where the embedding semantically represents the user input. “Semantically represents” as used herein with reference to an embedding means the embedding is a (vector) representation that captures at least semantic information/properties of the data from which the (vector) representation is generated.

The system may determine the semantic similarity of the user input to one or more dialogs involving the user. For example, the system may determine a semantic similarity between the user input embedding and stored dialog embeddings semantically representing dialogs involving the user. In some embodiments, the system may store embeddings of dialog summaries, where the embeddings semantically represent the dialog summaries, and may determine the semantic similarity between the user input embedding and the dialog summary embeddings.

If the system determines the user input embedding is not semantically similar to any of the stored dialog (summary) embeddings, the system may assign a new dialog identifier to the user input and may process the user input without using a dialog as context. Conversely, if the system determines the user input embedding is semantically similar to a stored dialog (summary) embedding, the system may assign the dialog identifier, of the semantically similar dialog, to the user input and may use the semantically similar dialog as context when processing the user input. Moreover, if the system determines the user input embedding is semantically similar to more than one stored dialog (summary) embedding, the system may present the user with an output requesting the user select one of the semantically similar dialogs to be used as context when processing the user input (i.e., select which dialog to resume). For example, the system may present the summaries of the semantically similar dialogs to the user. In response to receiving the user's selection, the system may assign the dialog identifier, of the selected dialog, to the user input and may use the selected dialog as context when processing the user input.

Sometime after outputting a response to a user input determined or selected to be semantically similar to a dialog, the system may update a summary of the dialog. As described herein, the system may store dialog summary embeddings semantically representing summaries of dialogs. By extension, the system may also store the underlying summaries. The system may include a generative (e.g., language) model and may prompt the model to generate a summary based on the summary of the semantically similar dialog, the user input, and the corresponding system response. The system may then store the updated summary and/or an updated summary embedding, semantically representing the updated summary, in association with the dialog's identifier. The updated summary embedding may then be used at runtime as described above to determine whether the corresponding dialog is to be used as context for processing a user input.

By storing dialog (summary) embeddings at the user identifier level, the user is able to resume a dialog (using the runtime processing described above) regardless of which user device receives the user input.

An aspect of the present disclosure relates to a computer-implemented method comprising (and a system configured to): receiving, from a first user device, input audio data including a spoken natural language input; generating text data corresponding to a transcription of the spoken natural language input; generating, using the text data, first embedding data corresponding to a semantic representation of the spoken natural language input; determining a user identifier associated with the input audio data; determining second embedding data associated with the user identifier, wherein the second embedding data corresponds to a semantic representation of a summary of a user-system dialog that was performed using a second user device; determining a value representing a semantic similarity between the first embedding data and the second embedding data; determining the value satisfies a threshold value; based on the value satisfying the threshold value, generating prompt data including: a first portion corresponding to the text data; and a second portion corresponding to the user-system dialog; processing, using a language model, the prompt data to determine a response to the spoken natural language input, wherein the language model uses the user-system dialog as context for processing the text data; and causing presentation of the response.

In some embodiments, the method further comprises (and the system is further configured to): receiving second text data corresponding to a second spoken natural language input; receiving third text data corresponding to a system-generated response to the second spoken natural language input; generating fourth text data by concatenating the second text data and the third text data; generating third embedding data corresponding to a semantic representation of the fourth text data; receiving fifth text data corresponding to a third spoken natural language input; receiving sixth text data corresponding to a system-generated response to the third spoken natural language input; generating seventh text data by concatenating the fifth text data and the sixth text data; generating fourth embedding data corresponding to a semantic representation of the seventh text data; determining a second value representing a semantic similarity between the third embedding data and the fourth embedding data; determining the second value satisfies the threshold value; based on the second value satisfying the threshold value, processing, using the language model, the second text data, the third text data, the fifth text data, and the sixth text data to determine eighth text data corresponding to a summary of the second spoken natural language input, the system-generated response to the second spoken natural language input, the third spoken natural language input, and the system-generated response to the third spoken natural language input; generating the second embedding data using the eighth text data; and storing the second embedding data in association with the user identifier prior to receiving the input audio data.

In some embodiments, the method further comprises (and the system is further configured to), based on the value satisfying the threshold value: processing, using the language model, the text data, second text data corresponding to the response, and third text data corresponding to the summary of the user-system dialog to determine fourth text data corresponding to an updated summary of the user-system dialog; determining third embedding data corresponding to a semantic representation of the updated summary; and storing the third embedding data in association with the user identifier.

In some embodiments, the method further comprises (and the system is further configured to): processing, using the language model, usage history data to determine a first number of topics in the usage history data; processing, using a semantic similarity component, the usage history data to determine a second number of topics in the usage history data; and determining the threshold value by minimizing a loss of the semantic similarity component based on the first number of topics and the second number of topics.

Another aspect of the present disclosure relates to a computer-implemented method comprising (and a system configured to): receiving, from a first user device, input data corresponding to a user input; generating, using the input data, first embedding data corresponding to a semantic representation of the user input; determining second embedding data corresponding to a semantic representation of a user-system dialog that was performed using a second user device; determining a value representing a semantic similarity between the first embedding data and the second embedding data; based on the value, processing, using a generative model, the user input and the user-system dialog to determine a response to the user input, wherein the generative model uses the user-system dialog as context for processing the user input; and causing presentation of the response.

In some embodiments, the method further comprises (and the system is further configured to): receiving second input data corresponding to a second user input; receiving first output data corresponding to a system-generated response to the second user input; generating, using the second input data and the first output data, third embedding data corresponding to a semantic representation of the second user input and the system-generated response to the second user input; receiving third input data corresponding to a third user input; receiving second output data corresponding to a system-generated response to the third user input; generating, using the third input data and the second output data, fourth embedding data corresponding to a semantic representation of the third user input and the system-generated response to the third user input; determining a second value representing a semantic similarity between the third embedding data and the fourth embedding data; based on the second value, determining summary data including a summary of the second user input, the system-generated response to the second user input, the third user input, and the system-generated response to the third user input; and generating the second embedding data using the summary data.

In some embodiments, the method further comprises (and the system is further configured to), prior to receiving the input data, storing the second embedding data in association with a user identifier associated with the input data.

In some embodiments, the method further comprises (and the system is further configured to), based on the value: processing, using the generative model, the input data, output data corresponding to the response, and summary data corresponding to a summary of the user-system dialog to determine updated summary data corresponding to an updated summary of the user-system dialog; determining, using the updated summary data, third embedding data corresponding to a semantic representation of the updated summary; and storing the third embedding data in association with a user identifier associated with the input data.

In some embodiments, the method further comprises (and the system is further configured to): processing, using the generative model, usage history data to determine a first number of topics in the usage history data; processing, using a semantic similarity component, the usage history data to determine a second number of topics in the usage history data; and determining a threshold semantic similarity value by minimizing a loss of the semantic similarity component based on the first number of topics and the second number of topics, wherein determining the response to the user input is based on the value satisfying the threshold semantic similarity value.

In some embodiments, the method further comprises (and the system is further configured to): receiving second input data corresponding to a second user input; generating, using the input data, third embedding data corresponding to a semantic representation of the second user input; determining the third embedding data is semantically similar to: fourth embedding data corresponding to a semantic representation of a second user-system dialog; and fifth embedding data corresponding to a semantic representation of a third user-system dialog; causing presentation of a request for a third user input selecting one of the second user-system dialog and the third user-system dialog; receiving third input data selecting the second user-system dialog; based on the third input data, processing, using the generative model, the second user input and the second user-system dialog to determine a response to the second user input, wherein the generative model uses the second user-system dialog as context for processing the second user input; and causing presentation of the response to the second user input.

In some embodiments, the method further comprises (and the system is further configured to): determining a summary of the user-system dialog; and determining the second embedding data to correspond to a semantic representation of the summary.

In some embodiments, the method further comprises (and the system is further configured to): determining a user identifier or a group identifier associated with the input data; and determining second embedding data is associated with the user identifier or the group identifier.

A system according to the present disclosure will ordinarily be configured to incorporate user permissions and only perform activities disclosed herein if approved by a user. As such, the systems, devices, components, and techniques described herein would be typically configured to restrict processing where appropriate and only process user data in a manner that ensures compliance with all appropriate laws, regulations, standards, and the like. The system and techniques can be implemented on a geographic basis to ensure compliance with laws in various jurisdictions and entities in which the components of the system and/or user are located.

Language modeling is the use of various statistical and probabilistic techniques to determine the probability of a given sequence of words occurring in a sentence. Language models analyze bodies of text data to provide a basis for their word predictions. The language models are generative models, that is they are configured to generate a sequence of data (for example representing text) based on input data, such as one more text prompts. In some embodiments, one or more of the language models may be a large language model. A Large Language Model (LLM) is a type of artificial intelligence system that is trained on vast amounts of text data to understand and generate human-like language in response to an input prompt. LLMs use deep learning algorithms, specifically neural networks, to learn patterns and relationships within the training data, enabling them to make predictions about language based on the context provided. These models can perform various natural language processing tasks, such as text generation, language translation, question answering, and sentiment analysis. An LLM analyzes an input prompt and generates an answer or response based on its training and understanding of the prompt. In some embodiments, a language model (or another type of generative model) may be further designed to process, understand, and/or generate multi-modal data including audio, text, image, and/or video.

LLMs are capable of producing coherent and contextually relevant text, making them useful tools in applications like chatbots, content creation, and virtual assistants. As compared to a relatively smaller language model, an LLM uses an expansive training dataset and can include a relatively large number of parameters (in the range of billions, trillions or more), hence they are called “large” language models. In some embodiments one or more of the language models (and their corresponding operations, discussed herein below) may be the same language model. As the name suggests, LLMs are characterized by their large size, often containing billions of parameters, which allows them to capture and learn from the intricacies and nuances of human language. Some well-known examples of LLMs include GPT (Generative Pre-trained Transformer) models, BERT (Bidirectional Encoder Representations from Transformers), and XLNet. A language model may be built using deep learning techniques, such as neural networks, and may be trained on extensive datasets that include text (or other type of data, such as multi-modal data including text, audio, image, video, etc.) from a broad range of sources, such as old/permitted books and websites, for natural language processing. As compared to a relatively smaller language model, an LLM uses an expansive training dataset and can include a relatively large number of parameters (in the range of billions, trillions or more), hence they are called “large” language models. In some embodiments one or more of the language models (and their corresponding operations, discussed herein below) may be the same language model.

In some embodiments, the language model(s) may be transformer-based sequence to sequence (seq2seq) models involving an encoder-decoder architecture. In an encoder-decoder architecture, the encoder may produce a representation of an input (e.g., audio, text, image, video, etc.) using a bidirectional encoding, and the decoder may use that representation to perform some task. In some such embodiments, one or more of the language models may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the language model may be pre-trained for approximately 1 trillion tokens. Being trained on CLM tasks, the language model(s) may be capable of in-context learning. Examples of such language models include some of the Amazon Alexa and Amazon Web Services (AWS) Nova family of generative models.

In other embodiments, the language model(s) may be a decoder-only architecture. The decoder-only architecture may use left-to-right (unidirectional) encoding of the input (e.g., audio, text, image, video, etc.). Examples of such language models include the Generative Pre-trained Transformer 3 (GPT-3), GPT-4, and other versions of GPT. GPT-3 reportedly has a capacity of (approximately) 175 billion machine learning parameters. GPT-4 reportedly has a capacity of (approximately) 1.76 trillion machine learning parameters.

Other examples of language models include BigScience Large Open-science Open-access Multilingual Language Model (BLOOM), Language Model for Dialogue Applications model (LaMDA), Bard, Large Language Model Meta AI (LLaMA), etc.

In some embodiments, the system may include one or more machine learning models (e.g., discriminative models) instead of or in addition to the generative model(s). Such machine learning model(s) may receive text and/or other types of data as inputs (e.g., audio, image, video, etc.), and may output text and/or the other types of data. Such model(s) may be neural network-based models, deep learning models, classifier models, autoregressive models, seq2seq models, etc.

In some embodiments, the input to a generative model may be in the form of a prompt. A prompt may be a natural language input, for example, a directive or request, for the generative model to generate an output according to the prompt. The output generated by the generative model may be a natural language output responsive to the prompt. In some embodiments, the output may additionally or instead be another type of data, such as audio, image, video, etc. The prompt and the output may be text in a particular language (e.g., English, Spanish, German, etc.). For example, for an example prompt “how do I cook rice?”, the generative model may output a recipe (e.g., a step-by-step process represented by text, audio, image, video, etc.) to cook rice. As another example, for an example prompt “I am hungry. What restaurants in the area are open?”, the generative model may output a list of restaurants near the user that are open at the time of the user prompt.

The generative models may be configured using various learning techniques. For example, in some embodiments, the language models may be configured using few-shot learning. In few-shot learning, the model learns how to learn to solve the given problem. In this approach, the model is provided with (e.g., in the prompt) a limited number of examples (i.e., “few shots”) from the new task, and the model uses this information to adapt and perform well on that task. Few-shot learning may require fewer amount of training data than implementing other fine-tuning techniques. Few-shot learning may be implemented by including examples (exemplars) in a prompt to the model and the model may perform in-context learning. For further example, in some embodiments, the language models may be configured using one-shot learning, which is similar to few-shot learning, except the model is provided with a single example (e.g., in the prompt). As another example, in some embodiments, the language models may be configured using zero-shot learning. In zero-shot learning, the model solves the given problem without examples of how to solve the specific/similar problem and just based on the model's training dataset. In this approach, the model is provided with data not observed during training, and the model learns to generate an appropriate output based on its learning with regard to other data. Other learning techniques may involve performing offline/training operations for fine-tuning (e.g., using supervised fine-tuning techniques) a pre-trained generative model for a particular task.

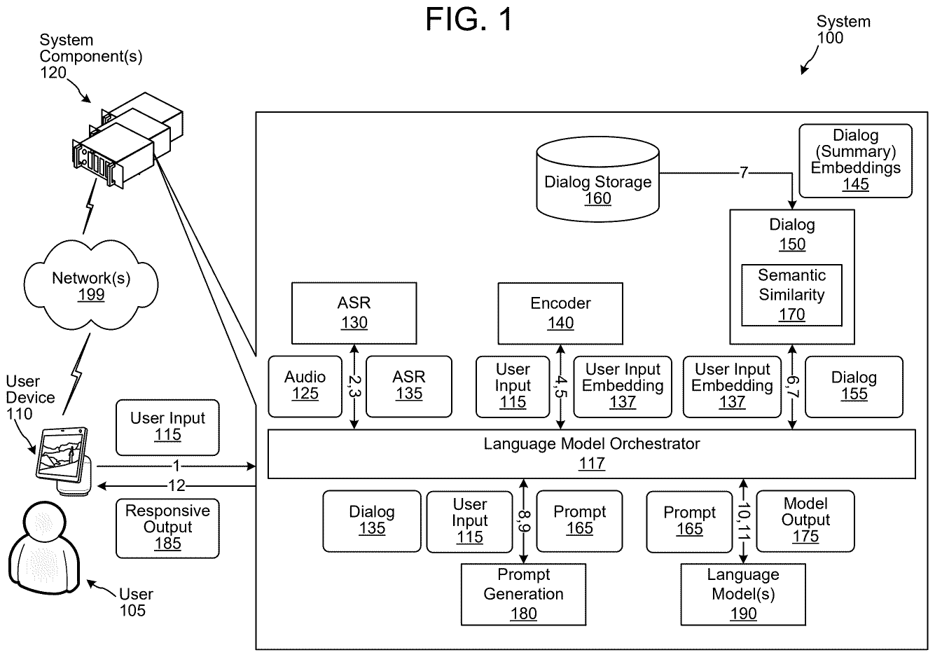

FIG. 1 is a conceptual diagram of a system 100 for determining a dialog for use as context when processing a user input. As illustrated, the system 100 may include a user device 110, local to a user 105, in communication with one or more system component(s) 120 via a network(s) 199. The network(s) 199 may include the Internet and/or any other wide-or local-area network, and may include wired, wireless, and/or cellular network hardware.

The user 105 may provide a user input to the user device 110 and the user device 110 may send (step 1), to the system component(s) 120, corresponding user input data 115 corresponding to the user input. The user input data 115 may include one or more types of data, such as text (e.g., a text or tokenized representation of the user input), audio, image, video, etc. Such data may be encoded/embedded data that represents the underlying type of data (e.g., text, audio, image, etc.). For example, the user input data 115 may include audio data when the user input is a spoken natural language user input. For further example, the user input data 115 may include text (or tokenized) data when the user input is a non-spoken (e.g., typed) natural language user input. As another example, the user input may correspond to an actuation of a physical button, data representing selection of a button displayed on a graphical user interface (GUI), image data of a gesture user input, combination of different types of user inputs (e.g., gesture and button actuation), etc. As a further example, the user input data 115 may include image data representing information being displayed at the user device 110 (e.g., on-screen context data) when the user 105 provides the user input or at substantially the same time as the user 105 provides the user input. As yet a further example, the user input data 115 may include audio data representing audio signals (e.g., background noise, audio from other devices such as TV, appliances, etc.) occurring in the environment of the user 105 that can be captured by the user device 110 (e.g., audio environment context). As yet a further example, the user input data 115 may include image data representing one or more objects in the environment of the user 105 (e.g., visual environment context). As yet a further example, the system may receive image data including text (and other data), and the user input data 115 may include text determined from the image data using optical character recognition or other techniques. The system 100 may include one or more components configured to process different types of user input data to generate a text or tokenized representation of the user input (e.g., the user input data 115).

The user input data 115 (or other input data) may be sent to a language model orchestrator component 117 of the system component(s) 120. The language model orchestrator component 117 may be configured to coordinate processing by various components of the system component(s) 120.

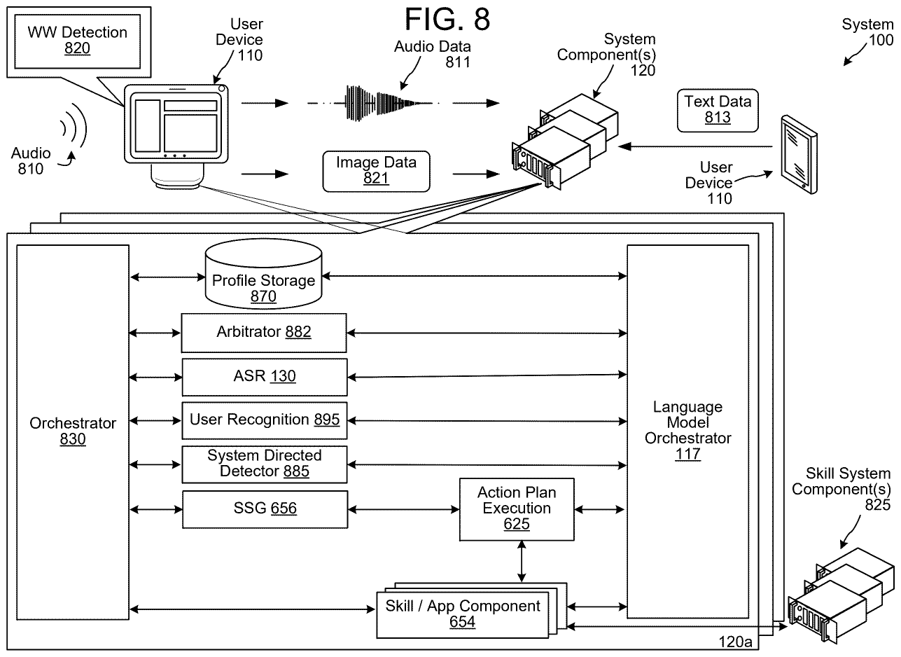

When the user input data 115 includes audio data 125, the language model orchestrator component 117 may send (step 2) the audio data 125 to an ASR component 130. The ASR component 130 may perform ASR processing on the audio data 125 to determine ASR data 135 including a transcript of a spoken natural language user input in the audio data 125. As described herein with respect to FIG. 8, the ASR component 130 may determine the ASR data 135 to include an N-best list including multiple ASR hypotheses and corresponding confidence scores representing what the user may have said. The ASR hypotheses may include text data, token data, ASR confidence score, etc. as representing the input utterance. The confidence score of each ASR hypothesis may indicate the level of confidence of the ASR component 130 that the corresponding hypothesis represents what the user said. The ASR component 130 may also determine token scores corresponding to each token/word of the ASR hypothesis, where the token score indicates the level of confidence of the ASR component 130 that the respective token/word was spoken by the user. The token scores may be identified as an entity score when the corresponding token relates to an entity. In some instances, the ASR data 135 may include only a top scoring ASR hypothesis. The ASR component 130 may send (step 3) the ASR data 135 to the language model orchestrator component 117.

The language model orchestrator component 117 may send (step 4) the user input data 115 to an encoder 140. The user input data 115, as input to the encoder 140, may include text or tokenized data. In embodiments where the user input data 115 includes the audio data 125, the language model orchestrator component 117 may send (step 4) the ASR data 135 to the encoder 140.

The encoder 140 may include a model (e.g., a neural network) that transforms input data into a vector representation that captures the semantic (e.g., meaning) content of the input data. The encoder 140 may receive raw data, for example, one or more sentences, and may use a learned mapping to transform the raw data into a numerical vector embedding representing the semantic meaning of the raw data. In some embodiments, the encoder 140 may include a sentence-level encoder.

The encoder 140 generates user input embedding data 137 semantically representing the user input data 115. That is, the user input embedding data 137 is a (vector) representation that captures at least semantic information/properties of the user input data 115 (or ASR data 135). The encoder 140 may be configured using art-and/or industry known techniques. The encoder 140 sends (step 5) the user input embedding data 137 to the language model orchestrator component 117, which may send (step 6) the user input embedding data 137 to a dialog component 150.

The dialog component 150 is configured to query a dialog storage 160 for data that may be used as context when processing the user input. The dialog component 150 may determine a user identifier of the user 105. For example, the user identifier may be determined based on it being associated with a device identifier of the user device 110 that sent the user input data 115 to the system component(s) 120. As another example, a user recognition component 895 (described with respect to FIG. 8) may be used to determine an identity of the user 105 and the user recognition component 895 may output the user's identifier for use by various components of the system 100. The dialog component 150 may query (step 7) the dialog storage 160 for dialog (summary) embeddings data 145 associated with the user's identifier, where the dialog (summary) embeddings data 145 are (vector) representations that capture at least semantic information/properties of the underlying dialogs (summaries).

Alternatively, after determining a user identifier of the user 105, the dialog component 150 may determine a group identifier associated with the user identifier (e.g., as stored in a profile storage 870 described herein with respect to FIG. 8), where the group identifier corresponds to a group of users including the user 105T. The dialog component 150 may query (step 7) the dialog storage 160 for dialog (summary) embeddings data 145 associated with the group identifier, where the dialog (summary) embeddings data 145 are (vector) representations that capture at least semantic information/properties of the underlying dialogs (summaries). In this use case, the dialog component 150 may enable a user of a group account (e.g., a household account) to resume a dialog initiated by another user (e.g., a dialog to plan a family trip).

The dialog storage 106 may store dialog (summary) embedding data 145 in association with a “private” indicator representing the corresponding dialog is only to be resumed for the user corresponding to the specific user identifier associated with the dialog (summary) embedding data 145. The user may provide an input indicating the dialog is to be marked private. Examples of such dialogs include ones relating to a surprise birthday party, research regarding a birthday gift, etc.

In instances where a dialog involves two or more users, the dialog's (summary) embedding data may be associated with each of the users'user identifiers, such that either user may resume the dialog as described herein.

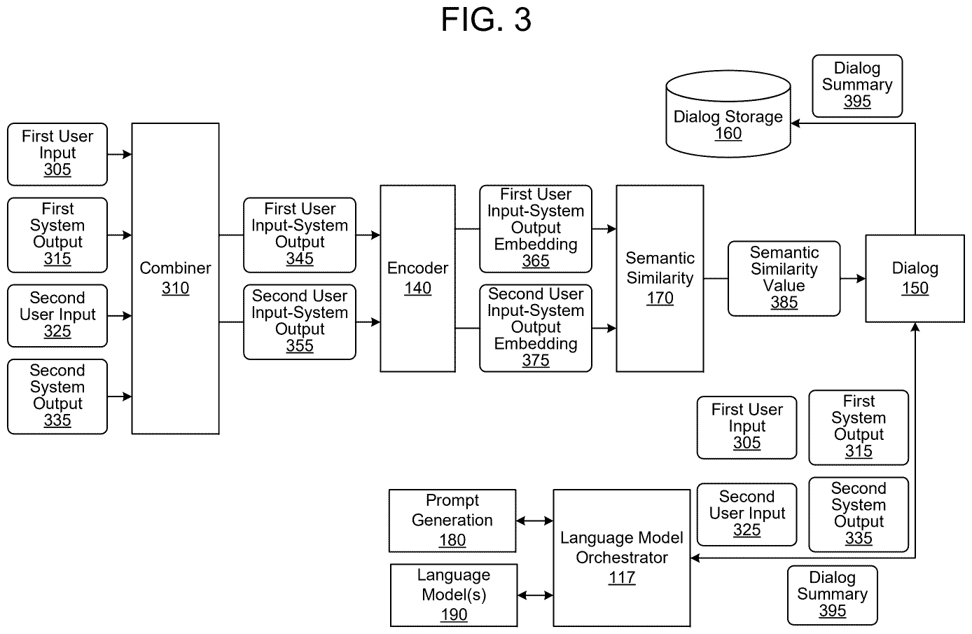

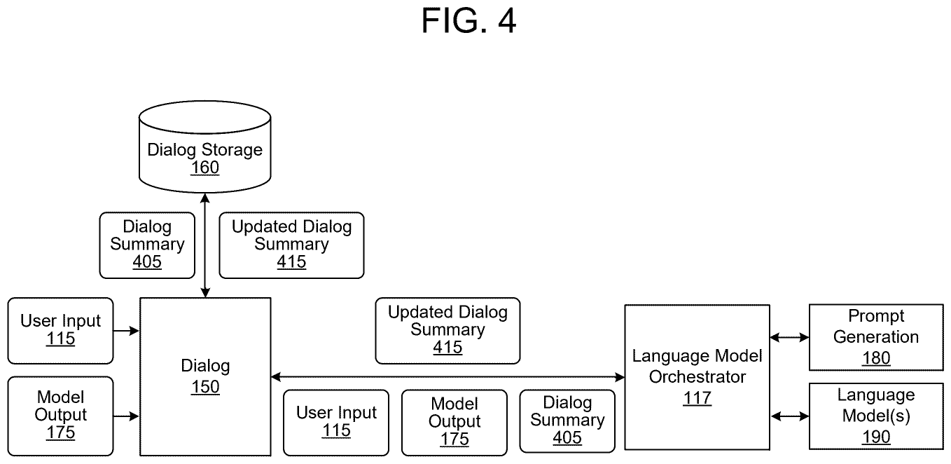

Generation of data for storage in the dialog storage 160 is described herein with respect to FIGS. 3 and 4.

The dialog component 150 may include a semantic similarity component 170 that determines the semantic similarity of two instances of embedding data (e.g., how closely two pieces of data relate in meaning/semantic content). For each instance of received dialog (summary) embedding data 145, the semantic similarity component 170 may determine a semantic similarity value (e.g., using cosine similarity or another similarity measuring technique) representing the semantic similarity between the instance of dialog (summary) embedding data 145 and the user input embedding data 137. In some embodiments, the semantic similarity component 170 may convert the semantic similarity value into a binned value (e.g., low, medium, or high) for output and further processing by one or more other system components.

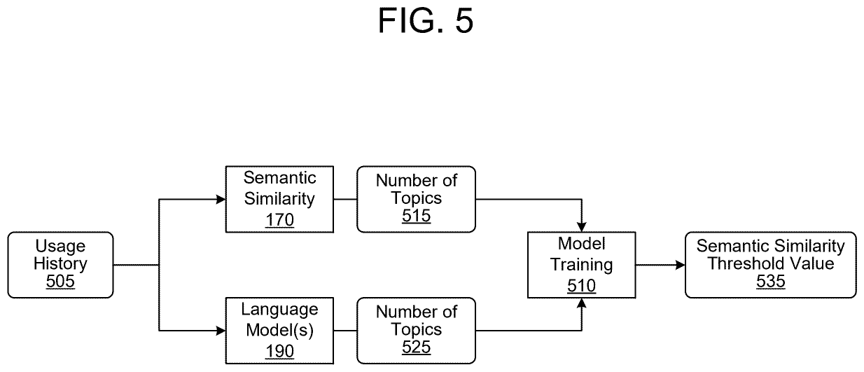

The dialog component 150 may determine whether an instance of dialog (summary) embedding data 145 is sufficiently semantically similar to the user input embedding data 137 based on whether the semantic similarity value, computed for the dialog (summary) embedding data 145, satisfies a threshold semantic similarity value. Like the semantic similarity value, the threshold semantic similarity value may be a binned value (e.g., low, medium, or high) or a numeric value (e.g., on a scale, such as 0 to 1). The semantic similarity threshold value may be configured in accordance with the teachings of FIG. 5.

In some situations, a user input may include anaphora or the like. For example, the user input may include “tell me more about that.” In such situations, the use of “that” is intended to mean the prior dialog is to be kept going. The system component(s) 120 may be configured to determine when a user input includes anaphora and the like indicating an immediately prior dialog is to be kept going. When the system component(s) 120 determines such, the system component(s) 120 (and more particularly the dialog component 150) may determine a dialog identifier associated with a past n user inputs of the user and may determine the dialog data associated with the dialog identifier for inclusion in the prompt for use by the language model 190 as context when responding to the user input.

In some embodiments, the system component(s) 120 (and more particularly the semantic similarity component 170) may determine a semantic similarity value(s) representing a semantic similarity between the user input embedding data 137 and user input embedding data of n past user inputs of the user. If a semantic similarity value satisfies a threshold value, the system component(s) 120 (and more particularly the dialog component 150) may determine the dialog identifier associated with the semantically similar past user input and determine the dialog data associated with the dialog identifier for inclusion in the prompt for use by the language model 190 as context when responding to the instant user input.

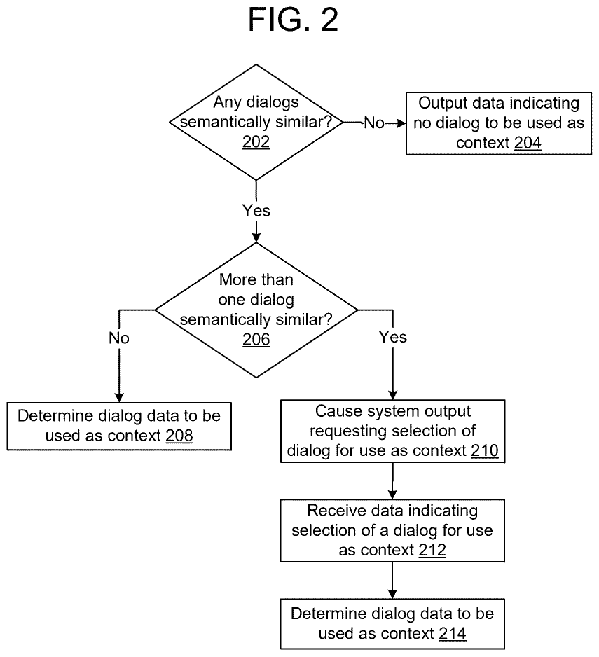

The dialog component 150 may determine whether a dialog should be used as context for processing of the user input in accordance with FIG. 2. With reference to FIG. 2, the dialog component 150 may determine (step 202) whether any of the user's dialogs are semantically similar to the user input. In other words, the dialog component 150 may determine whether any of the semantic similarity values, generated by the semantic similarity component 170 for the dialog (summary) embeddings data 145, satisfy the semantic similarity threshold value. If none satisfy the threshold value, the dialog component 150 may generate (step 204) data indicating none of the user's dialogs are to be used as context for processing the user input.

Conversely, if at least one of the semantic similarity values satisfies the threshold value, the dialog component 150 may determine (step 206) whether more than one of the dialogs are semantically similar to the user input. In other words, the dialog component 150 may determine whether more than one of the semantic similarity values satisfy the threshold value. If only one of the semantic similarity values satisfies the threshold value, the dialog component 150 may determine (step 208) dialog data, of the dialog, to be used as context for processing the user input. For example, the dialog component 150 may query the dialog storage 160 for dialog data (e.g., one or more instances of user input data and corresponding one or more instances of system output data) associated with the dialog (summary) embedding whose semantic similarity value satisfies the threshold value. In some embodiments, the dialog component 150 may determine a dialog identifier associated with the dialog (summary) embedding whose semantic similarity value satisfies the threshold value, and may query the dialog storage 160 for dialog data associated with the dialog identifier.

Conversely, if more than one of the semantic similarity values satisfies the threshold value, the dialog component 150 may cause (step 210) the system 100 to output a request for the user to select one of the dialogs for use as context when processing the user input. The system 100 may cause the user device 110, that received the user input, to output the request. The request may take various forms (e.g., displayed content and/or synthesized speech). In some embodiments, the request may provide the user with the summaries of the dialogs whose dialog (summary) embedding data 145 are associated with semantic similarity values satisfying the threshold value.

The user 105 may provide a user input to the user device 110 and the user device 110 may send corresponding user input data to the system component(s) 120. The user may provide the user input in various ways and the user input data may include one or more types of data, similar to that described above with respect to the user input data 115 and corresponding user input.

The system component(s) 120 may process the user input to determine which dialog the user input selects for use as context and data indicating the selected dialog may be sent to the dialog component 150. After receiving (step 212) the data indicating the selected dialog, the dialog component 150 may determine (step 214) dialog data, of the selected dialog, to be used as context for processing the user input. For example, the dialog component 150 may query the dialog storage 160 for dialog data (e.g., one or more instances of user input data and corresponding one or more instances of system output data) associated with the dialog summary selected by the user. In some embodiments, the dialog component 150 may determine a dialog identifier associated with the dialog summary and may query the dialog storage 160 for dialog data associated with the dialog identifier.

Referring again to FIG. 1, the dialog component 150 may send (step 7) to the language model orchestrator component 117, either data indicating no dialog is to be used as context (generated at step 204 of FIG. 2) or dialog data 155 to be used as context (determined at step 208 or 214 of FIG. 2).

In response to receiving data indicating no dialog is to be used as context for processing the user input, the language model orchestrator component 117 may send (step 8) the user input data 115 to a prompt generation component 180. Alternatively, in response to receiving the dialog data 155, the language model orchestrator component 117 may send (step 8) the user input data 115 and the dialog data 155 to the prompt generation component 180. In embodiments where the user input data 115 includes the audio data 125, the language model orchestrator component 117 may send (step 8) the ASR data 135 to the prompt generation component 180.

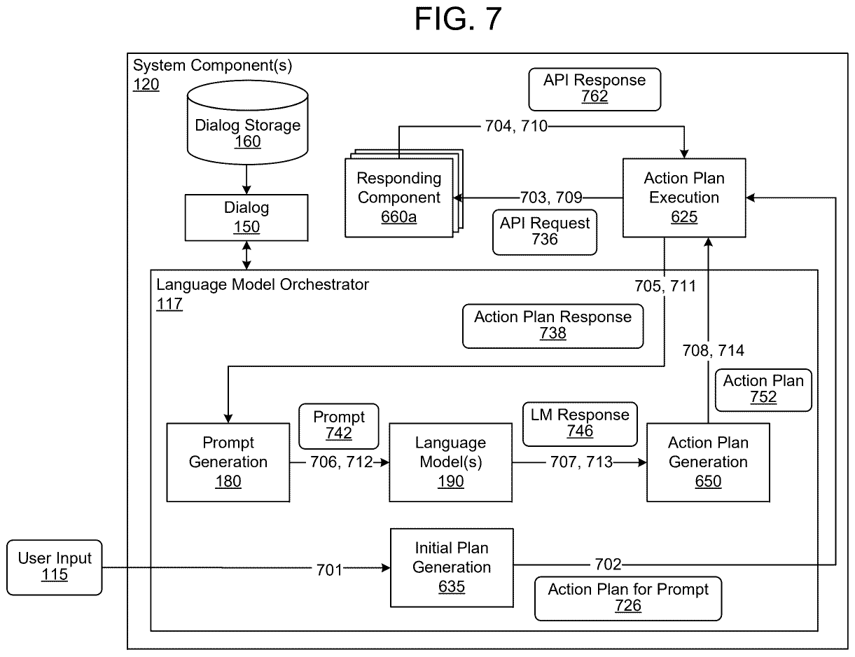

Using the user input data 115 (and the dialog data 155 when received), the prompt generation component 180 may determine a prompt 165 for a language model 190. The prompt 165 may be a natural language input (e.g., a natural language request, a natural language instruction, etc.). In some embodiments, the prompt 165 may include information in a manner that the language model 190 is trained for. Additional details of the prompt generation component 180 are described in relation to FIG. 7.

The prompt 165 may include the user input data 115 (or a representation thereof) and, when present, the dialog data (or a representation thereof) for use as context when processing the user input data 115. The prompt 165 may include other context for processing the user input data 115. For example, the prompt 165 may include relevant APIs or API descriptions, etc. In some embodiments, the prompt 165 may include one or more exemplars (e.g., in-context learning examples) for processing the user input data 115.

The prompt 165 may include indicators (e.g., labels, specific tokens, etc.) to identify certain information. In example embodiments, the prompt 165 may include a “User” indicator (to indicate that the following string of characters/tokens are the user input), an “Exemplar” indicator (to indicate exemplars), and so on.

In some embodiments, the prompt 165 may include a request for the language model 190 to output a response that satisfies one or more conditions. Such conditions may relate to generating a response that is unbiased (toward protected classes, such as gender, race, age, etc.), non-harmful, profanity-free, etc. For example, the prompt 165 may include “Please generate a polite, respectful, and safe response and one that does not violate protected class policy.”

The prompt 165 may direct the language model 190 to generate an output (e.g. tokens) representing an action(s) [e.g., API call(s)] corresponding to the user input, where execution of the action(s) can be done to retrieve information to determine a response to the user's input, perform the user requested action, retrieve information to perform another action, etc.

The prompt generation component 180 may send (step 9) the prompt 165 to the language model orchestrator component 117, which may send (step 10) the prompt 165 to the language model 190. The language model 190 processes the prompt 165 to generate a model output data 175. The model output data 175 may be a natural language output generated based on the prompt 165. The model output data 175 may include text tokens. In other embodiments, where the language model 190 may be a multi-modal model, the model output data 175 may include other types of tokens, for example, audio tokens, image tokens, etc. The model output data 175 may follow the format included in the prompt 165 or that the language model 190 is trained to follow.

The language model 190 may send (step 11) the model output data 175 to the language model orchestrator component 117. The system component(s) 120 may then use the model output data 175 to generate responsive output data 185, which may be sent (step 12) to the user device 110 for presentation to the user 105 (e.g., as synthesized speech and/or displayed content).

Referring to FIG. 3, the following description relates to how the system component(s) 120 may generate and store dialog summary (embedding) data for use at runtime (which is described above with respect to FIGS. 1 and 2). The processing of FIG. 3 can be used to group user inputs and system outputs into dialogs even when the user provides user inputs in between user inputs of the dialog. For example, a user may input “tell me about snowboarding,” “tell me about rock climbing,” and “what are some good snowboarding locations.” Using the teachings of FIG. 3, the system 100 of the present disclosure is able to determine the first and third user inputs belong to the same dialog (based on semantic similarity) even though the intervening second user input is not part of the dialog.

The system component(s) 120 may include a combiner component 310 may receive user input data and system output data associated with a single user identifier. For example and as illustrated in FIG. 3, the combiner component 310 may receive first user input data 305, first system output data 315 corresponding to the first user input data 305, second user input data 325, and second system output data 335 corresponding to the second user input data 325, where each of these instances of data is associated with the same user identifier.

FIG. 3 is illustrative. As such, the combiner component 310 may receive more than two instances of user input data and corresponding system output data, and the processing described with respect to FIG. 3 may be performed using the more than two instances.

The combiner component 310 combines (e.g., concatenates) each pair of user input data and system output data into a single instance of data. For example, the combiner component 310 may combine (e.g., concatenate) the first user input data 305 and first system output data 315 into first user input-system output data 345, combine (e.g., concatenate) the second user input data 325 and second system output data 335 into second user input-system output data 355, etc.

The data output by the combiner component 310 may be input to the encoder 140. The encoder 140, in this situation, generates user input-system output embedding data semantically representing the user input-system output data input therein. That is, the user input-system output embedding data is a (vector) representation that captures at least semantic information/properties of the user input-system output data from which it is generated. For example, the encoder 140 may generate first user input-system output embedding data 365 semantically representing the first user input-system output data 345, second user input-system output embedding data 375 semantically representing the second user input-system output data 355, etc.

The data output by the encoder 140 may be input to the semantic similarity component 170. In this situation, the semantic similarity component 170 may, for each instance of received user input-system output embedding data, determine a semantic similarity value (e.g., cosine similarity) representing the semantic similarity between the instance of user input-system output embedding data and another instance of user input-system output embedding data associated with the same user identifier. The semantic similarity value may be a binned value (e.g., low, medium, or high) or a numeric value (e.g., on a scale, such as 0 to 1). For example, the semantic similarity component 170 may determine a semantic similarity value 385 representing a semantic similarity between the first user input-system output embedding data 365 and the second user input-system output embedding data 375.

The dialog component 150 may determine whether two instances of user input-system output embedding data belong to the same dialog (i.e., are to be associated with the same dialog identifier) based on their semantic similarity value. The dialog component 150 may determine two instances of user input-system output embedding data belong to the same dialog if their semantic similarity value satisfies a threshold semantic similarity value. The semantic similarity threshold value may be configured in accordance with the teachings of FIG. 5. Like the semantic similarity value, the threshold semantic similarity value may be a binned value (e.g., low, medium, or high) or a numeric value (e.g., on a scale, such as 0 to 1).

If the dialog component 150 determines a semantic similarity value satisfies the threshold semantic similarity value, the dialog component 150 may send the corresponding user input and system output data to the language model orchestrator component 117. For example, if the dialog component 150 determines the semantic similarity value 385 satisfies the threshold semantic similarity value, the dialog component 150 may send the first user input data 305, first system output data 315, second user input data 325, and second system output data 335 to the language model orchestrator component 117. The language model orchestrator component 117 may in turn send the received data to the prompt generation component 180.

Using the data received from the language model orchestrator component 117 (e.g., the first user input data 305, first system output data 315, second user input data 325, and second system output data 335 in the context of FIG. 3), the prompt generation component 180 may determine a prompt for the language model 190 to generate a summary of the received data (i.e., generate a dialog summary). The prompt may be a natural language input (e.g., a natural language request, a natural language instruction, etc.). In some embodiments, the prompt may include information in a manner that the language model 190 is trained for.

The prompt 165 may include one or more exemplars (e.g., in-context learning examples) of dialog summaries.

The prompt 165 may include indicators (e.g., labels, specific tokens, etc.) to identify certain information. In example embodiments, the prompt 165 may include a “User” indicator (to indicate that the following string of characters/tokens are the user input), an “Exemplar” indicator (to indicate exemplars), and so on.

In some embodiments, the prompt 165 may include a request for the language model 190 to output a response that satisfies one or more conditions. Such conditions may relate to generating a response that is unbiased (toward protected classes, such as gender, race, age, etc.), non-harmful, profanity-free, etc. For example, the prompt may include “Please generate a polite, respectful, and safe dialog summary and one that does not violate protected class policy.”

The prompt generation component 180 may send the prompt to the language model orchestrator component 117, which may send the prompt to the language model 190. The language model 190 processes the prompt to generate dialog summary data 395. The dialog summary data 395 may be a natural language output generated based on the prompt. The dialog summary data 395 may include text tokens. In some embodiments, the dialog summary data 395 may include other modalities (other types of data) that may be generated by the language model 190 or another generative model, or may be determined (e.g., inserted) by another system component. In such embodiments, the dialog summary data 395 may include image data and/or video data (e.g., an image(s) or video(s) provided by the user during the dialog, an image(s) or video(s) output by the system during the dialog, an image(s) or video(s) representing a topic of the dialog, etc.). In some embodiments, the dialog summary data 395 may include audio data (e.g., audio input by the user during the dialog, audio output by the system during the dialog, audio representing a theme music associated with the dialog, etc.).

The language model 190 may send the dialog summary data 395 to the language model orchestrator component 117, which may send the dialog summary data 395 to the dialog component 150. In some embodiments, the dialog component 150 may cause the dialog summary data 395 to be stored in association with the user identifier (e.g., associated with the first user input data 305, first system output data 315, second user input data 325, and second system output data 335 in the context of FIG. 3) and a unique dialog identifier in the dialog storage 160. In some embodiments, the dialog component 150 may send the dialog summary data 395 to the encoder 140, the encoder 140 may generate dialog summary embedding data semantically representing the dialog summary data 395, and the dialog component 150 may cause the dialog summary embedding data to be stored in association with the user identifier and the unique dialog identifier in the dialog storage 160. In some embodiments, the dialog component 150 may cause both the dialog summary data 395 and the dialog summary embedding data to be stored in association with the user identifier and the unique dialog identifier in the dialog storage 160.

Once the dialog summary and/or dialog summary embedding data are stored as described above, they can be used at runtime as described herein with respect to FIG. 1.

The processing of FIG. 3 may be performed using user input data and system output data associated with timestamps within a past n (e.g., month, week, etc.) amount of time.

The processing of FIG. 3 may not be performed with “transactional” user input-system output pairs. A transactional user input-system output pair may be one that request results in the system component(s) 120 performing discrete, non-conversational action, such as setting a timer or alarm, unlocking/locking a door, opening/closing blinds, etc. The system component(s) 120 may include a component configured to classifier a user input-system output pair as either “transactional” or “conversational.” The system component(s) 120 may only input “conversational” user input-system output pairs into the combiner component 310 for the purposes of the processing described with respect to FIG. 3.

As two dialogs are performed between a user and the system, the semantics of the dialogs may merge to a point where they become the same dialog from a semantic similarity perspective. The processing described above with respect to FIG. 3 may be used to determine whether two dialogs are to be merged into a single dialog. For example, the combiner component 310 may receive the user input data and corresponding system output data associated with two different dialog identifiers. The combiner component 310 may combine (e.g., concatenate) the user input data and system output data of each dialog into a single instance of dialog data. The two instances of dialog data output by the combiner component 310 may be input to the encoder 140. In an alternative embodiment, the combiner may be skipped and the summaries of two different dialogs may be input to the encoder 140. In any event, the encoder 140 may generate two instances of dialog (summary) embedding data semantically representing the dialogs (summaries) input therein. The data output by the encoder 140 may be input to the semantic similarity component 170, which may determine a semantic similarity value (e.g., cosine similarity) representing the semantic similarity between the two instances of dialog (summary) embedding data. The dialog component 150 may determine whether the two dialogs have merged into a single dialog based on their semantic similarity value. If the dialog component 150 determines the semantic similarity value satisfies a threshold semantic similarity value, the dialog component 150 may send the corresponding two instances of dialog (summary) data to the language model orchestrator component 117. Using the data received from the language model orchestrator component 117, the prompt generation component 180 may determine a prompt for the language model 190 to generate a summary of the received two instances of dialog (summary) data. The prompt generation component 180 may send the prompt to the language model orchestrator component 117, which may send the prompt to the language model 190. The language model 190 processes the prompt to generate dialog summary data. The language model 190 may send the dialog summary data to the language model orchestrator component 117, which may send the dialog summary data 395 to the dialog component 150. In some embodiments, the dialog component 150 may cause the dialog summary data to be stored in association with the user identifier and a unique dialog identifier in the dialog storage 160. In some embodiments, the dialog component 150 may send the dialog summary data to the encoder 140, the encoder 140 may generate dialog summary embedding data semantically representing the dialog summary data, and the dialog component 150 may cause the dialog summary embedding data to be stored in association with the user identifier and the unique dialog identifier in the dialog storage 160. In some embodiments, the dialog component 150 may cause both the dialog summary data and the dialog summary embedding data to be stored in association with the user identifier and the unique dialog identifier in the dialog storage 160.

Moreover, as a dialog is performed between a user and the system, the semantics of the dialog may diverge into two dialogs from a semantic similarity perspective. The processing described above with respect to FIG. 3 may be used to determine whether a dialog is to be split into two dialogs. For example, the combiner component 310 may receive two user input-system output data pairs associated with a single dialog identifier. The combiner component 310 may combine (e.g., concatenate) the user input data and system output data of each pair into a single instance of data. The two instances of data output by the combiner component 310 may be input to the encoder 140. The encoder 140 may generate two instances of user input-system output pair embedding data semantically representing the user input-system output pairs input therein. The data output by the encoder 140 may be input to the semantic similarity component 170, which may determine a semantic similarity value (e.g., cosine similarity) representing the semantic similarity between the two instances of user input-system output pair embedding data. The dialog component 150 may determine whether the two user input-system output pairs should be split into two dialogs based on their semantic similarity value. If the dialog component 150 determines the semantic similarity value fails to satisfy a threshold semantic similarity value, the dialog component 150 may send each of the two user input-system output pairs to the language model orchestrator component 117, which may process in conjunction with the prompt generation component 180 and language model 190 as described herein to generate two dialog summaries, one for each user input-system output pair. In some embodiments, the dialog component 150 may cause the dialog summaries to be stored in association with the user identifier and unique dialog identifiers in the dialog storage 160. In some embodiments, the dialog component 150 may send the dialog summaries to the encoder 140, the encoder 140 may generate dialog summary embedding data semantically representing the dialog summaries, and the dialog component 150 may cause the dialog summary embedding data to be stored in association with the user identifier and unique dialog identifiers in the dialog storage 160. In some embodiments, the dialog component 150 may cause both the dialog summaries and the dialog summary embedding data to be stored in association with the user identifier and the unique dialog identifiers in the dialog storage 160.

Referring to FIG. 4, the following description relates to how the system component(s) 120 may update dialog summary (embedding) data for use at runtime (which is described above with respect to FIGS. 1 and 2). After the language model 190 sends the model output data 175 (corresponding to a response to the user input data 115) to the language model orchestrator component 117, the language model orchestrator component 117 may send the user input data 115 and model output data 175 to the dialog component 150.

The dialog component 150 may query the dialog storage 160 for dialog summary data 405 corresponding to the dialog determined (in FIG. 1) to be used as context for processing the user input data 115. The dialog component 150 may send the user input data 115, model output data 175, and dialog summary data 405 to the language model orchestrator component 117. The language model orchestrator component 117 may in turn send the received data to the prompt generation component 180.

Using the data received from the language model orchestrator component 117 (e.g., the user input data 115, model output data 175, and dialog summary data 405), the prompt generation component 180 may determine a prompt for the language model 190 to generate a summary of the received data (i.e., generate an updated summary). The prompt may be a natural language input (e.g., a natural language request, a natural language instruction, etc.). In some embodiments, the prompt may include information in a manner that the language model 190 is trained for.

The prompt 165 may include one or more exemplars (e.g., in-context learning examples) of dialog summaries.

The prompt 165 may include indicators (e.g., labels, specific tokens, etc.) to identify certain information. In example embodiments, the prompt 165 may include a “User” indicator (to indicate that the following string of characters/tokens are the user input), an “Exemplar” indicator (to indicate exemplars), and so on.

In some embodiments, the prompt 165 may include a request for the language model 190 to output a response that satisfies one or more conditions. Such conditions may relate to generating a response that is unbiased (toward protected classes, such as gender, race, age, etc.), non-harmful, profanity-free, etc. For example, the prompt may include “Please generate a polite, respectful, and safe dialog summary and one that does not violate protected class policy.”

The prompt generation component 180 may send the prompt to the language model orchestrator component 117, which may send the prompt to the language model 190. The language model 190 processes the prompt to generate updated dialog summary data 415. The updated dialog summary data 415 may be a natural language output generated based on the prompt. The updated dialog summary data 415 may include text tokens.

The language model 190 may send the updated dialog summary data 415 to the language model orchestrator component 117, which may send the updated dialog summary data 415 to the dialog component 150. In some embodiments, the dialog component 150 may cause the updated dialog summary data 415 to be stored (in the dialog storage 160) in association with the user identifier (e.g., associated with the user input data 115) and the dialog identifier previously established for the dialog. In some embodiments, the dialog component 150 may send the updated dialog summary data 415 to the encoder 140, the encoder 140 may generate updated dialog summary embedding data semantically representing the updated dialog summary data 415, and the dialog component 150 may cause the updated dialog summary embedding data to be stored (in the dialog storage 160) in association with the user identifier and the dialog identifier previously established for the dialog. In some embodiments, the dialog component 150 may cause both the updated dialog summary data 415 and the updated dialog summary embedding data to be stored (in the dialog storage 160) in association with the user identifier and the dialog identifier previously established for the dialog.

Once the updated dialog summary and/or updated dialog summary embedding data are stored as described above, they can be used at runtime as described herein with respect to FIG. 1.

Generating the updated dialog summary using the prior dialog summary and the new user input-system output pair may ensure the language model 190 weighs the user input-system output pair correctly when generating the updated dialog summary. As the user input-system output pair is the most recent interaction of the dialog, the language model 190 should, in at least some instances, weight the user input-system output pair more than prior user input-system outputs pairs of the dialog. If the language model 190 were to generate the updated dialog summary based on all user input-system output pairs of the dialog, the language model 190 may, in at least some instances, not assign more weight to newer user input-system output pair(s) and, thus, the updated dialog summary may not adequately represent a shift in the topic to the present state of the dialog.

Moreover, dialogs may contain a number of user input-system output pairs which cannot (from a token perspective) all be represented in the prompt to the language model 190. Thus, generating the updated dialog summary using the prior dialog summary and the new user input-system output pair ensures compliance with prompt size and may result in more efficient processing by the language model 190.

With reference to FIG. 5, the following describes how the herein mentioned semantic similarity threshold value can be determined. The system component(s) 120 may store usage history data 505 including user input-system output pairs of dialogs corresponding to various, different users of the system 100. The usage history data 505 may be input to both the semantic similarity component 170 and the language model 190. While not illustrated, the usage history data 505 may be input to the prompt generation component 180, which may generate a prompt instructing the language model 190 to determine a number of topics in the usage history data 505. Such a prompt effectively instructions the language model 190 to determine the number of dialogs in the usage history data 505.

The semantic similarity component 170 may process the usage history data 505 and generate data 515 indicating a number of topics (i.e., dialogs) the semantic similarity component 170 determined in the usage history data 505. Likewise, the language model 190 may process the usage history data 505 (in the input prompt) and generate data 525 indicating a number of topics (i.e., dialogs) the language model 190 determined in the usage history data 505.

The data 515 and 525 may be input to a model training component 510 that determines a semantic similarity threshold value 535 based on the data 515 and 525. For example, the model training component 510 may determine the semantic similarity threshold value 535 by minimizing a loss of the semantic similarity component 170 based on the data 515 and 525.

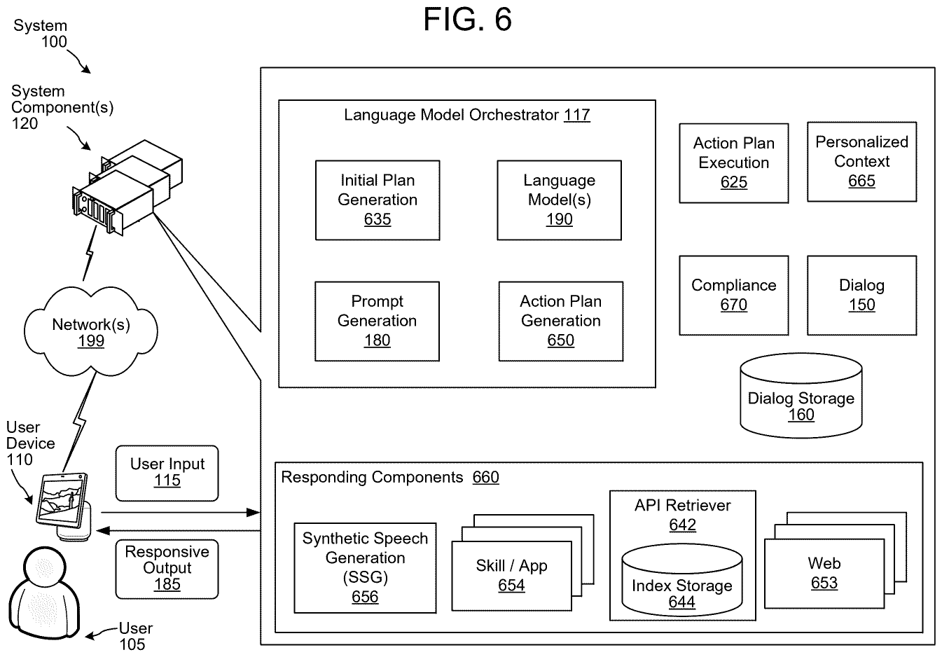

FIG. 6 illustrates further example components included in the system 100 configured to use a language-model based approach to determine an action to be performed in response to a user input and determine a response to be presented to a user 105. As shown in FIG. 6, the system 100 may include a user device 110, local to the user 105, in communication with one or more system component(s) 120 via a network(s) 199. The network(s) 199 may include the Internet and/or any other wide-or local-area network, and may include wired, wireless, and/or cellular network hardware.

In some embodiments, the system component(s) 120 may include various components that may support processing by a language model, such as a language model orchestrator component 117. In example embodiments, the language model orchestrator component 117 may include an initial plan generation component 635, a prompt generation component 180, the language model 190, and an action plan generation component 650. The system component(s) 120 may further include an action plan execution component 625 configured to facilitate/cause performance of actions that may be determined by the language model 190. The system component(s) 120 may further include one or more responding components 660 that may perform the actions.

The responding components 660 may be configured to perform an action related to a user input, including, but not limited to retrieving information potentially relevant for determining a response to the user input (e.g., data from a knowledge base, Internet search, database, an application, etc. ; context related to the interaction; relevant exemplars for a prompt to the language model; relevant application programming interfaces (APIs); etc.), operating a user device (e.g., a smart home device such as a TV, lights, a kitchen appliance, etc.), determining a synthesized speech output, or other actions described herein. As shown in FIG. 6, the responding components 660 may include an API retriever component 642 (further described below), a synthesized speech generation (SSG) component 656, one or more skill/app components 654 and other components described herein.

APIs are a way for one program/component to interact with another. API calls are a mechanism by which the program/component interact. An API call, or API command, is a message sent to a system component asking an API to perform an action, provide a service or information, or the like. An API call may be formatted for the particular API and may include a particular command, optionally using particular arguments and argument values. API calls may be used for a variety of purposes, such as controlling other devices (e.g., an API call of turn_on_device (device=“indoor light 1”) corresponds to a command for a component to turn on a device associated with the identifier “indoor light 1”), obtaining information from other components (e.g., an API call of InfoQA. question (“Who is the president of USA?”) corresponds to a command for a component to find and provide an answer to the indicated question), and performing other actions (e.g., generating synthesized speech, searching data sources, etc.). The system 100 may interact with the responding components 660 via API calls.

The language model orchestrator component 117 may be configured to orchestrate processing by the language model 190. In some embodiments, the language model 190 may be configured to perform one or more stages of processing, which may be referred to as a task generation stage, an action (or directive) generation stage, and a response generation stage.

The processing stages may be performed in a particular order. For example, during a first stage of processing, the language model 190 may be tasked with performing task generation to generate a list of tasks to be performed in order to respond to a user input. During a second stage of processing, based on the list of tasks, the language model 190 may be tasked with performing action generation to generate action requests (or directives) for a responding component(s) 660 to perform an action(s) related to the tasks/user input. During a third stage of processing, based on information received from the responding component(s) 660, the language model 190 may be tasked with generating a response to the user input and/or causing a component(s) of the system 100 to perform further action(s). Further details are described herein in relation to FIG. 7.

In some cases, a subset of the stages may be performed. For some user inputs, the language model 190 may only perform the task generation stage and the response generation stage, where a response to a user input is generated by the language model 190 using parametric knowledge. For example, for a user input “What kind of fruit is lemon?”, the language model 190 may determine that the task is to answer the user's question and may generate a response “Lemon is a citrus fruit that grows on tress” based on the model's parameter knowledge learned during configuration/training operations. In such examples, the language model 190 may not determine an action that is to be performed using a system component, such as sending a request for information to a knowledge base (e.g., the language model 190 may respond without using external knowledge).

In some embodiments, the system may use Retrieval-Augmented Generation (RAG) techniques to inform processing of a language model. RAG techniques may involve referencing an authoritative knowledge base or other type of data source outside of the model's training data sources before generating a response by the model. RAG techniques may extend the already powerful capabilities of language models to specific domains, an organization's internal knowledge base, etc., without the need to retrain the model. In some embodiments, information (e.g., relevant facts, up-to-date information, current/trending topics, etc.) from one or more components (e.g., responding component(s) 660) may be provided to the language model 190 and the model may generate a output based on the received information.

In some embodiments, the language model orchestrator component 117 may be configured to orchestrate processing by multiple different language models, where an individual language model may perform one (or more) of the processing stages described above. For example, a first language model may perform task generation, a second language model may perform action generation, and a third language model may perform response generation. In some embodiments, the language models may be different types of models, for example, a first language model may be a text-to-text generative model, a second language model may be a multi-modal generative model, a third language model may be a text-to-speech generative model, etc. In some embodiments, the language models may be different sizes (e.g., number of parameters), may have different processing capabilities, etc.

Some embodiments may enable use of other components, such as plugins, with the language model 190, where the plugins may add functionality and features to the language model capabilities. For example, the plugins may be used to perform mathematical calculations (e.g., a calculator plugin), statistical analysis (e.g., a statistics plugin), natural language translation, speech generation, etc. For further example, the plugins may additionally, or alternatively, be used to perform an action responsive to a user input based on the response generated by the language model. As a further example, the plugins may cause the language model to process and output according to an enabled plugin, which may result in a different response, reasoning, processing, etc. from the language model than when the plugin is not enabled. In some cases, a user or a system may enable a plugin(s) for use with the language model.

The system component(s) 120 may include other processing components configured to process user inputs and other type of inputs (e.g., sensor data, audio data, data indicative of an event occurring, etc.) received via the user device 110. In example embodiments, the system component(s) 120 may process spoken inputs using ASR processing. The system component(s) 120 may also be configured to process non-spoken inputs, such as gestures, textual inputs, selection of GUI elements, selection of device buttons, etc. The system component(s) 120 may also include other components to understand an input, determine an action to be performed in response to receiving the input, generate an output responsive to the input, and the like. Such other components may perform natural language processing, SSG processing, etc., some of which are described herein in relation to FIG. 8.

As shown in FIG. 6, the system component(s) 120 may receive user input data 115, which may be provided to the language model orchestrator component 117 (as shown in FIG. 7). In some instances, the user input data 115 may include one or more types of data, such as text (e.g., a text or tokenized representation of a user input), audio, image, video, etc. Such data may be encoded/embedded data that represent the underlying type of data (e.g., text, audio, image, etc.). For example, the user input data 115 may include text (or tokenized) data when the user input is a natural language user input. In some embodiments, an ASR component 130 of the system 100 may receive audio data representing a spoken natural language user input from the user 105. The ASR component 130 may perform ASR processing on the audio data to determine ASR data representing the spoken user input, which may correspond to a transcript of the user input. As described herein, with respect to FIG. 8, the ASR component 130 may determine ASR data that includes an ASR N-best list including multiple ASR hypotheses and corresponding confidence scores representing what the user may have said. The ASR hypotheses may include text data, token data, ASR confidence score, etc. as representing the input utterance. The confidence score of each ASR hypothesis may indicate the ASR component's 130 level of confidence that the corresponding hypothesis represents what the user said. The ASR component 130 may also determine token scores corresponding to each token/word of the ASR hypothesis, where the token score indicates the ASR component's 130 level of confidence that the respective token/word was spoken by the user. The token scores may be identified as an entity score when the corresponding token relates to an entity. In some instances, the user input data 115 may include a top scoring ASR hypothesis of the ASR data. As an even further example, in some embodiments, the user input may correspond to an actuation of a physical button, data representing selection of a button displayed on a graphical user interface (GUI), image data of a gesture user input, combination of different types of user inputs (e.g., gesture and button actuation), etc. In such embodiments, the system 100 may include one or more components configured to process such user inputs to generate the text or tokenized representation of the user input (e.g., the user input data 115). As a further example, the user input data 115 may include image data representing information being displayed at the user device 110 (e.g., on-screen context data) when the user 105 provides the user input or at substantially the same time as the user 105 provides the user input. As yet a further example, the user input data 115 may include audio data representing audio signals (e.g., background noise, audio from other devices such as TV, appliances, etc.) occurring in the environment of the user 105 that can be captured by the user device 110 (e.g., audio environment context). As yet a further example, the user input data 115 may include image data representing one or more objects in the environment of the user 105 (e.g., visual environment context). As yet a further example, the system may receive image data including text (and other data), and the user input data 115 may include text determined from the image data using optical character recognition or other techniques.

In some embodiments, the system component(s) 120 may receive input data that may not be provided directly/explicitly by a user. Such other type of input data may be processed in a similar manner as the user input data 115 as described herein. Such other type of input data may be received in response to detection of an event. Example events include change in a device state (e.g., front door opening, garage door closing, TV turned off, thermostat detecting a particular temperature, etc.), occurrence of an acoustic event (e.g., baby crying, appliance beeping, glass breaking, etc.), presence of a user (e.g., a user approaching the user device 110, a user entering the home, etc.), occurrence of an event indicated by a user (e.g., a reminder/notification requested by the user, sporting event score change, start of a TV program, calendar event, etc.), and others. In some embodiments, the system 100 may process the input data and generate a response/output. For example, the input data may be received in response to detection of a user generally or a particular user, an expiration of a timer, a time of day, detection of a change in the weather, a device state change, etc. In some embodiments, the input data may include data corresponding to the event, such as sensor data (e.g., image data, audio data, proximity sensor data, short-range wireless signal data, etc.), a description associated with the timer, the time of day, a description of the change in weather, an indication of the device state that changed, etc. The system 100 may include one or more components configured to process the input data to generate a natural language representation of the input data. The system 100, for example, the language model orchestrator component 117 may process the input data and may cause performance of an action. For example, in response to detecting a garage door opening, the system 100 may cause garage lights to turn on, living room lights to turn on, etc. As another example, in response to detecting an oven beeping, the system 100 may cause a user device 110 (e.g., a smartphone, a smart speaker, etc.) to present an alert to the user. The language model orchestrator component 117 may process the input data to generate tasks (e.g., an action plan) that may cause the foregoing example actions to be performed.

FIG. 7 illustrates example processing of the user input data 115 by the system component(s) 120 using the language model 190. Although the figure and discussion of the present disclosure illustrate certain components and steps in a particular order, the components may be implemented in a different manner (as well as certain components removed or added) and the steps described may be performed in a different order (as well as certain steps removed or added) without departing from the present disclosure.

In some embodiments, the language model 190 may perform iterative processing (e.g., multiple processing cycles, multiple processing stages, etc.) with respect to an instance of user input data 115. Such iterative processing is illustrated and described herein with respect to FIG. 7. For example, in a first iteration of processing the language model 190 may receive a first prompt from the prompt generation component 180, in response to which the language model 190 may determine one or more tasks to be performed with respect to the user input data 115, then at least one of the determined task(s) may be performed via the action plan execution component 625, the results of the performed task(s) may be provided to the language model 190 via a second prompt, in response to which the language model 190 may determine further tasks to be performed or may determine that a (final) response to the user input is determined.

The initial plan generation component 635 may be configured to determine various information relevant to processing of the user input data 115 by the language model orchestrator component 117. The initial plan generation component 635 may generate an action plan (e.g., action plan for prompt data 726) representing one or more tasks/actions to be performed to determine the various relevant information. The relevant information may be included in a prompt to the language model 190. The initial plan generation component 635 may receive (step 701) the user input data 115 representing a user input from the user 105. Based on the user input data 115, the initial plan generation component 635 may determine information relevant for processing the user input data 115 and may output (step 702) the action plan for prompt data 726. The action plan for prompt data 726 may include one or more tasks to be performed to retrieve the relevant information. The tasks may be represented as action descriptions, API requests/calls, API descriptions, requests to a component(s) (e.g., the responding components 660), and the like. Examples tasks that may be included in the action plan for prompt data 726 may relate to obtaining certain information like context data, user profile data, user preferences, available/relevant exemplars, available/relevant APIs, etc.

In example embodiments, the initial plan generation component 635 may determine one or more types of context data relevant for the user input data 115. Types of context data may include user context (e.g., user location, user profile identifier, user demographics, user profile data, user preferences, personalized catalogs, enabled skills/applications, etc.), device context (e.g., device type, device identifier, device location (e.g., living room, kitchen, office, etc.), device capabilities, device state, etc.), environmental context (e.g., time/date the past user input was received/processed, device that received the user input, device that responded to the user input, objects proximate to the device/user, background audio/noises, state/status of device(s) in the user's environment (e.g., TV is on, thermostat temperature, etc.), dialog context (e.g., prior user inputs of a dialog, prior system responses of the dialog, dialog topic, actions performed during the dialog, etc.), and the like. As an example, if the user input data 115 corresponds to operation of a device (e.g., the user input corresponds to a smart home domain), the initial plan generation component 635 may determine that device context information, in particular device states for the devices associated with the user/user profile of the user 105, may be relevant information. As another example, if the user input data 115 corresponds to output of media, such as music, movies, TV shows, etc., the initial plan generation component 635 may determine that user context information, in particular user preference for media genre associated with the user/user profile of the user 105, may be relevant information.

Based on the type of context data determined to be relevant, the initial plan generation component 635 may output the action plan for prompt data 726 to include a request for the type(s) of context data. For example, if device context is relevant information, then the action plan for prompt data 726 may include an API call/description corresponding to a component (e.g., a device state component, a smart home component, a user profile storage, etc.) capable of providing device information. As another example, if user context is relevant information, then the action plan for prompt data 726 may include an API call/description corresponding to a component (e.g., a user profile storage, a personalized context component, etc.) capable of providing user information.

In some embodiments, the initial plan generation component 635 may determine one or more components or types of components that may be relevant for processing the user input data 115. As an example, if the user input data 115 corresponds to operation of a device (e.g., the user input corresponds to a smart home domain), the initial plan generation component 635 may determine that components (e.g., APIs) corresponding to device operation or smart home domain may be relevant, and the initial plan generation component 635 may output the action plan for prompt data 726 to include device operation components or smart home domain components. As another example, if the user input data 115 corresponds to output of media, the initial plan generation component 635 may determine components corresponding to media output or music domain may be relevant, and the initial plan generation component 635 may output the action plan for prompt data 726 to include media output components or music domain components.

In some embodiments, the initial plan generation component 635 may determine a query to retrieve exemplars and/or APIs relevant for processing the user input data 115 using the language model 190. As used herein, an exemplar refers to information that may be included in a prompt to a language model that provides an example of how the language model is to process or respond, including, among other things, what actions the language model can request performance of. A prompt may include more than one exemplar. Few shot learning or in-context learning by the language model is enabled by including the exemplars in the prompt. The query (or request) to retrieve relevant exemplars and/or APIs may be included in the action plan for prompt data 726. The query (or an API request based on the query) may be processed by the responding component 660 (e.g., an exemplar retriever component, the API retriever component 642, etc.). The query, in some embodiments, may include the user input data 115 or a portion or representation thereof.

The initial plan generation component 635 may employ one or more techniques to determine relevant information or to determine the tasks to obtain relevant information. Examples of such techniques include using one or more of machine learning models (e.g., classifiers), statistical models, rules engines, etc. to determine the relevant information. The initial plan generation component 635 may determine a topic/category corresponding to the user input data 115, a (semantically or lexically) similar past user input and relevant information corresponding to the similar past user input, and the like.

In example embodiments, the initial plan generation component 635 may use a language model to determine the types of information relevant for processing the user input data 115. The initial plan generation component 635 may input a prompt to the language model, for example, “What types of information is relevant for responding to the user input: [user input data 115]”, and the language model may output one or more types of context data, one or more types of components, etc. that may be relevant. In some embodiments, the initial plan generation component 635 may input a prompt to the language model 190 requesting relevant information for the user input data 115.

The action plan for prompt data 726, which includes types of relevant information for the user input data 115 or tasks to be performed to obtain the relevant information, may be processed by the action plan execution component 625 to retrieve the relevant information. The action plan execution component 625 may process the action plan for prompt data 726 to generate one or more requests to perform an action (e.g., API requests 736) for a particular responding component 660. For example, if the action plan for prompt data 726 indicates that device information/context is relevant, then the action plan execution component 625 may generate an API request 736 for a responding component 660a capable of providing the device information, where the API request 736 may include a user profile identifier associated with the user 105, a device identifier associated with the user device 110, and/or other information based on information required in the API call for the responding component 660a.

The API request 736 may be sent (step 703) to the corresponding responding component(s) 660. The responding component(s) 660 may include components that the action plan execution component 625 may communicate with via API requests or other type requests. As shown in FIG. 6, the responding component(s) 660 may include one or more skill/app components 654, the SSG component 656 (e.g., configured to convert input data to audio data representing synthesized speech), one or more web components 653 (e.g., corresponding to one or more websites) and the API retriever component 642 (e.g., configured to provide APIs and corresponding information supported by the system 100). The responding component(s) 660 may also include an orchestrator component 830 (e.g., configured to facilitate processing by other system component(s) 120 such as those shown in FIG. 8), a context source component (e.g., configured to provide user context data, device context data, environmental context data, dialog context data, personalized context data, etc.), a multimodal response component (e.g., configured to respond to a user input via outputs in more than one data form), a content moderation component (e.g., configured to moderate certain types of content such as biased content, harmful content, offensive content, etc.), a smart home devices component (e.g., configured to provide device information such as device state, device capabilities, etc.), a language model-based agent (e.g., a component that uses a language model (e.g., a LLM) or other type of generative model to provide information), an exemplar provider component (e.g., configured to respond to a query for relevant exemplars), a knowledge base component (e.g., including one or more knowledge bases or other structured data that can be searched to obtain information), an entity resolution component (e.g., configured to determine specific entities corresponding to entities represented in a user input or language model output), and the like.

In response to receiving the API request 736 (at step 703), the responding component(s) 660 may provide (step 704) an API response(s) 762 to the action plan execution component 625. At step 703, the API request(s) 736 is based on the action plan for prompt data 726, and thus, at step 704, the API response(s) 762 may include information relevant for processing the user input data 115. In examples, the API response(s) 762 may include relevant context information (e.g., device context, user context, environment context, dialog context, personalized context, etc.), relevant APIs and/or API descriptions for processing the user input data (e.g., API(s) for operating devices, API(s) for outputting media content, etc.), relevant exemplars, and other relevant information requested via the action plan for prompt data 726.

In example embodiments, the API request 736 may be sent to the API retriever component 642. In such cases, the API request 736 may include a query to retrieve relevant APIs based on the user input data 115. The API retriever component 642 may be configured to receive a search query and output one or more APIs or API data corresponding to (e.g., satisfying, matching, etc.) the search query. API data may include an API call, an API description, and other information associated with the API. In some embodiments, the API retriever component 642 may include or may be in communication with an index storage 644 (shown in FIG. 6). The index storage 644 may store various information associated with multiple APIs. Examples of information stored in the index storage 644 include: API/component descriptions (e.g., a description of one or more function that the API can be used to perform), API arguments (e.g., parameter inputs, input types, examples of input values, examples of output values, output type, etc.), identifiers for components corresponding to the API (e.g., alphanumerical component ID, component name, etc.), and other information. In some embodiments, the index storage 644 may include other information associated with the API, such as historical accuracy/defect rate, historical latency value, feedback (e.g., user satisfaction/feedback, system-based feedback), etc. The index storage 644 may also include sample user inputs corresponding to the API, where the sample user input may represent a user input for which the API can perform an action for.

The API retriever component 642 may apply one or more retrieval techniques to determine API data corresponding to the search query. For example, the API retriever component 642 may compare one or more APIs included/represented in the index storage 644 to the user input data 115 represented in the search query to determine one or more APIs (top-k list). Such comparison may involve a semantic comparison between the user input data 115 and the API data. In some embodiments, the API retriever component 642 may use a neural-based retrieval technique that may involve determining an encoded representation of the user input/search query and comparing (e.g., using cosine distance) the encoded representation(s) of the API data in the index storage 644. The relevant APIs may be included in the API response 762.

In a non-limiting example, for a user input “book a flight”, the API retriever component 642 may determine one or more API calls corresponding to booking a flight (e.g., Bookflight. location (“departing airport code”, “arrival airport code”), Bookflight. date (“departing date”), bookflight. rountrip (“departing location”, “arrival location”, “departure date”, “return date”), AirlineBookFlight (“departing airport code”, “arrival airport code”), etc.).

Some embodiments may include an exemplar provider component that may operate in a similar manner as the API retriever component 642 in terms of implementing one or more retrieval techniques to determine exemplars corresponding to (e.g., satisfying, matching, etc.) a search query based on the user input data 115. The exemplar provider component may search an index storage including various information related to multiple different exemplars. In some embodiments, the index storage may include sample user inputs associated with an exemplar, and the relevant exemplars may be retrieved based on a comparison of the sample user inputs and the user input data 115. The retrieved exemplars may be included in the API response 762.

The information from the API response(s) 762 may be included in a prompt to the language model 190. The action plan execution component 625 may determine action plan response data 738 based on the API response(s) 762. The action plan execution component 625 may combine (e.g., aggregate, summarize, de-duplicate, etc.) multiple API responses 762 to generate the action plan response data 738. In some examples, the action plan response data 738 may be the same or similar to the API response(s) 762. The action plan execution component 625 may send (step 705) the action plan response data 738 to the prompt generation component 180.

Using the action plan response data 738 and the dialog data 155, the prompt generation component 180 may determine a prompt 742 for the language model 190. The prompt 742 may be a natural language input (e.g., a natural language request, a natural language instruction, etc.). In some embodiments, the prompt 742 may include information in a manner that the language model 190 is trained for. The prompt generation component 180 may send (step 706) the prompt 742 to the language model 190, where the prompt 742 may include the user input data 115 (or a representation of the user input data 115) and the relevant information for processing the user input data 115. For example, the prompt 742 (at step 706) may include relevant context data, relevant APIs or API descriptions, etc. that may be included in the action plan response data 738. In some embodiments, the prompt 742 may include a request or directive for the language model 190 to respond to the user input data 115. In some embodiments, the prompt 742 may include one or more exemplars (e.g., in-context learning examples) for processing the user input data 115.

The prompt 742 may include indicators (e.g., labels, specific tokens, etc.) to identify certain information. In example embodiments, the prompt 742 may include a “User” indicator (to indicate that the following string of characters/tokens are the user input), an “Exemplar” indicator (to indicate exemplars), and so on.

In some embodiments, the prompts for the language model described herein may include a request for the language model to output a response that satisfies certain conditions. Such conditions may relate to generating a response that is unbiased (toward protected classes, such as gender, race, age, etc.), non-harmful, profanity-free, etc. For example, prompt data generated by a prompt generation component described herein may include “Please generate a polite, respectful, and safe response and one that does not violate protected class policy.”

In some embodiments, the prompt 742 may include an indication the processing stages (e.g., the task generation stage, the action generation stage, and the response generation stage) that the language model 190 is to perform. In some examples, for the task generation stage, the prompt 742 may direct the language model 190 to generate an output (e.g., tokens) representing the model's interpretation of the user input and/or one or more tasks to be performed to respond to the user input (the model output may be, for example, the user is requesting [intent of the user input], the user wants to [desired user action], need to determine [information needed to properly process the user input], etc.). For the task generation stage, the prompt 742 may also direct the language model 190 to prioritize a list of tasks to be performed, if more than one task is to be performed and select one (or more) task for the current iteration of processing.

In some examples, for the action generation stage, the prompt 742 may direct the language model 190 to generate an output (e.g. tokens) representing an action(s) (or directive(s)) and/or an API call(s) corresponding to the user input, where performance of the action(s) or execution of the API(s) can be done to retrieve information to determine a response to the user's input, perform the user requested action, retrieve information/data to perform other tasks on the task list, etc. In some examples, for the action generation stage, the prompt 742 may direct the language model 190 to process the results of the action(s)/API(s) determined by the language model 190, and to determine whether a response to the user input can be generated or whether there are further tasks to be performed from the task list.

In some examples, for the response generation stage, the prompt 742 may direct the language model 190 to generate an output (e.g., tokens) representing a response (e.g., a final response) to the user input data 115. In examples, the language model 190 may be directed to generate the response based on the results of performing the action(s)/API(s).

The prompt generation component 180 may send (step 706) the prompt 742 to the language model 190, which may process the prompt 742 to generate a language model (LM) response 746. The LM response 746 may be a natural language output generated based on the prompt 742. The LM response 746 may include text tokens. In other embodiments, where the language model 190 may be a multi-modal model, the LM response 746 may include other types of tokens, for example, audio tokens, image tokens, etc.

Based on receiving the prompt 742 at step 706, the language model 190 may generate the LM response 746 at step 707, where the instant LM response 746 may include outputs corresponding to the task generation stage and the action generation stage. The LM response 746 may include an action for determining information relevant to or responsive to the user input data 115. For example, the LM response 746 may include an action to search a knowledge base (e.g., to find a response to a user question), an action to determine information from a particular skill/app or language model-based agent (e.g., to determine current weather information, to determine a cost of an item, to book travel, etc.), an action to operate a device (e.g., turn on lights, set thermostat to a particular temperature, etc.), an action to request information from the user 105, etc.

In some embodiments, the LM response 746 may include an API or API description corresponding to the determined action. For example, the LM response 746 may include an API to operate a device or an API call(s) to output media content. The language model 190 may determine the actions and/or the API information based on the relevant APIs included in the prompt 742. The language model 190 may generate actions and/or API information that is not based on (e.g., correspond to, is similar to, etc.) the relevant APIs included in the prompt 742 (for example, the language model 190 may generate incorrect/unsupported actions and/or API information).

The LM response 746 may follow the format included in the prompt 742 or that the language model 190 is trained to follow. An example prompt 742 may be:
{

Please process the following user input and context data to determine at least one action or API to execute and generate a response to the user.

First determine a task to perform (use “Task” label), then determine an API to perform the task (use “Action” label), then process the results from the API, and then generate a response to the user input (use “Response” label). You may determine multiple tasks to perform. You may have to process iteratively.
User: Turn on living room TV
Available context:
   User devices: “living room TV”=[device id]
   “living room TV” device state=Off
Available APIs:
   TurnOn.device (device)
   TurnVolumeUp.device (device)
   SetTVChannel (device, input channel)
}

Based on processing the above example prompt 742, an example LM response 746 (at step 707) may be:
{
Task: User wants to turn on living room TV that is operation of a user device.
Action: I need an API to operate a device. TurnOn.device (device=“living room TV”)
}

The LM response 746 may be sent (step 707) to the action plan generation component 650, which may determine action plan data 752. As described herein, the language model 190 may generate tokens in sequence, as such, the language model 190 may generate portions of the LM response 746 in a tokens-by-tokens basis. In some embodiments, the LM response 746 may be processed by the action plan generation component 650 based on the language model 190 generating the tokens representing the action or corresponding to the action generation stage.

The action plan generation component 650 may process the LM response 746 to identify one or more actions/APIs generated by the language model 190. In examples, the action plan generation component 650 may parse the tokens/text included in the LM response 746 to extract tokens/text representing an action or API. In some embodiments, the action plan generation component 650 may be configured to determine one or more components (e.g., responding components 660a-n) configured to perform the identified action or API. Based on the LM response 746, the action plan generation component 650 may determine the action plan data 752, which may in turn cause performance of an action (e.g., execution of API calls) to determine a potential responses(s) to the user input. The action plan data 752 may include one or more APIs to be executed, where the APIs may be determined based on (e.g., extracted from) the LM response 746. For example, if the LM response 746 includes an action of “determine weather forecast for today” or an API call of “GetWeather.location ([city])”, then the action plan generation component 650 may determine the action plan data 752 to include an API call “GetWeather.location ([city])” and include an identifier for the responding component(s) 660a (e.g., a weather skill component). Instead of or in addition to an API call, the action plan data 752 may include a request to perform an action, an API description, etc. In some embodiments, the action plan generation component 650 may determine the responding components 660 based on user permissions, subscriptions, authorization or other use-enabling information associated with the user 105 (e.g., included in user profile data).

In some embodiments, the action plan generation component 650 may be configured to determine more than one responding component 660 to perform the action/execute the API indicated in the LM response 746. In some embodiments, the action plan generation component 650 may determine APIs corresponding to multiple responding components 660. For example, for the “GetWeather.location ([city])” API, the action plan data 752 may include an identifier for a first weather skill component, an identifier for a second weather skill component, an identifier for a search engine component, etc.

The action plan data 752 may be sent (step 708) to the action plan execution component 625. The action plan execution component 625 may identify the APIs in the action plan data 752 and generate executable API calls for the corresponding responding components 660. Based on the action plan data (received at step 708), the action plan execution component 625 may generate an additional (a second) API request (or multiple API requests) 736. The (additional/second) API request(s) 736 may be sent (step 709) to the responding component(s) 660. For example, the action plan execution component 625 may send a first API call to a first responding component 660a and a second API call to a second responding component 660b.

In some cases, the action plan data 752 may include incomplete API calls and the action plan execution component 625 may be configured to generate executable API calls (e.g., complete API calls) corresponding to the action plan data 752.

The action plan execution component 625 may generate one or more executable API calls including one or more parameters using information included in the action plan data 752 and/or various other contextual information (e.g., speaker recognition results, a user ID, user profile information (e.g., age, gender, location, language, geographic marketplace, etc.), device ID, device profile information, device state indicators, a dialog history, and/or a interaction history associated with the user and/or the device, etc.). In some embodiments, the various contextual information may be contextual information not provided to the language model orchestrator component 117. Prior to generating the executable commands, the action plan execution component 625 may modify (e.g., remove, filter, preempt, etc.) a directive included in the action plan data 752 that is determined to be in conflict with a system operating policy. The action plan execution component 625 may generate one or more additional executable commands corresponding to directives not included in the action plan data 752.

In response to receiving the API request(s) 736 (at step 709), the responding component(s) 660 may send (step 710) an (additional/second) API response(s) 762 to the action plan execution component 625. The action plan execution component 625 may determine (additional/second) action plan response data 738 based on the (additional/second) API response(s) 762. The action plan execution component 625 may combine (e.g., aggregate, summarize, de-duplicate, etc.) multiple API responses 762 to generate the action plan response data 738. In some examples, the action plan response data 738 may be the same or similar to the API response(s) 762. In some examples, the action plan response data 738 may include an identifier associated with the responding component 660 that provided the API response 762. For example, the (additional/second) action plan response data 738 may include first weather information from a first weather skill component, second weather information from a second weather skill component, third weather information from a search engine component, etc. In some embodiments, the action plan execution component 625 may remove/filter information from the API response 762 that is determined to include information not beneficial to the processing by the language model 190.

The action plan execution component 625 may send (step 711) the (additional/second) action plan response data 738 to the prompt generation component 180. The information from the API response(s) 762 may be included, by the prompt generation component 180, in a (additional/second) prompt to the language model 190. The prompt generation component 180 may generate the second prompt 742 to include the action plan response data 738 or a representation thereof. The second prompt 742 may also include information from the prior/first prompt (from step 706). For example, the second prompt 742 may include the user input data 115 (or a representation thereof), the relevant information for processing the user input data 115 (e.g., relevant context data, relevant API information, relevant exemplars, etc.), the processing stages information, and the action plan response data 738 (from step 711). In some embodiments, the second prompt 742 may also include at least a portion of the LM response 746 generated during a prior iteration of processing (e.g., the outputs based on performing the task generation stage and the action generation stage) to indicate actions/results of the prior iteration of processing by the language model 190. The second prompt 742 may include an indicator (e.g., label, identifier, etc.) associated with the action plan response data 738 to indicate, to the language model 190, that the string of characters/tokens following the indicator represent information determined based on performance of the actions determined during the action generation stage.

The second prompt 742 may be sent (step 712) to the language model 190 for processing. At this point, the language model 190 may perform the action generation stage of processing the results of the performed actions, which may involve interpreting or understanding the results included in the action plan response data 738. The language model 190 may generate (step 713) a (additional/second) LM response 746 based on the second prompt 742. The second prompt 742 may include a request or directive to the language model 190 to perform further processing with respect to the user input data 115. As described above, the second prompt 742 may provide, among other things, responses/results of performance of the action determined by the language model 190 determined during the prior iteration of processing. The language model 190 may generate further actions to be performed to respond to the user input data 115 (as part of the action generation stage) or may generate a (final/user-facing) response to the user input data 115 (as part of the response generation stage).

An example second prompt 742 may be:
{

Please process the following user input and context data to determine at least one action or API to execute and generate a response to the user.

First determine a task to perform (use “Task” label), then determine an API to perform the task (use “Action” label), then process the results from the API, and then generate a response to the user input (use “Response” label). You may determine multiple tasks to perform. You may have to process iteratively.
User: Turn on living room TV
Available context:
   User devices: “living room TV”=[device id]
   “living room TV” device state=Off
Available APIs:
   TurnOn.device (device)
   TurnVolumeUp.device (device)
   SetTVChannel (device, input channel)
Prior Iteration:
   Action: TurnOn.device (device=“living room TV”)
TurnOn.device (device=“living room TV”); API response: “living room TV” device state=ON
}

Based on the above example prompt 742, an example LM response 746 may be:
{
Task: User wants to turn on living room TV that is operation of a user device.
Action: I need an API to operate a device. TurnOn.device (device=“living room TV”)
Action result is “living room TV” device state=ON
Response: The living room TV is on now. Can I help you with anything else?
}

As described herein, the language model 190 may generate the LM response 746 on tokens-by-tokens basis. As such, in some examples, the second LM response 746 may include additional tokens (e.g., newly generated tokens) to the first LM response 746 (from step 707). In other examples, the second LM response 746 may include different tokens than the first LM response 746, where the currently generated tokens may represent outputs for further steps of the action generation stage and/or the response generation stage.

The language model 190 may determine further actions/APIs to be performed in a similar manner as described above. Such further actions/APIs may be based on any tasks, included in the task list generated during the task generation stage, that are still to be performed (e.g., a first task of booking a flight may be done, now a second task of booking a hotel is to be performed). Additionally or alternatively, the further actions/APIs may be based on the results included in the action plan response data 738 (at step 711) (e.g., an API response from a responding component 660 may indicate that additional information is needed to perform an action).

The language model 190 may determine a (final) response to the user input, where the response is to be presented to the user 105 via the user device 110. In other cases, the response may be presented via another user device 110 associated with the user 105. The language model 190 may determine the final response based on the results included in the action plan response data 738 (from step 711). For example, the language model 190 may summarize the results, may combine the results, may generate an interpretation of the results, etc. In a non-limiting example, the language model 190 may combine weather information from two or more responding components (e.g., combine high/low temperature information from a first responding component with humidity information from a second responding component). In another non-limiting example, the language model 190 may interpret results from a knowledge base component to determine a response to the specific user query (e.g., from a biographical search result for a historical person, a birthplace and siblings information may be extracted to determine a response to a user query “tell me about [person's] childhood”).

In some examples, the language model 190 may generate the further action to be performed is requesting additional information from the user 105. Such further action, in some embodiments, may be labeled as “Response” so that the action plan generation component 650 may cause a request to be output to the user 105.

The second LM response 746 may be sent (step 713) to the action plan generation component 650, which may determine (step 714) the (additional/second) action plan data 752. In some examples, the second LM response 746 sent to the action plan generation component 650 may include further action(s)/API(s) to be executed, which may be labeled with “Action.” In some examples, the second LM response 746 may include a final response to the user input, which may be labeled with “Response.”

Based on the tokens corresponding to the “Action” label, the action plan generation component 650 may determine the action plan data 752 to include one or more actions, one or more API calls and/or one or more responding components 660 corresponding to the action(s)/API(s) determined by the language model 190.

Based on the tokens corresponding to the “Response” label, the action plan generation component 650 may determine the action plan data 752 to include one or more actions, one or more API calls and/or one or more responding components 660 to present the output tokens to the user 105 as a response to the user input. For example, the action plan data 752 may include an identifier for the SSG component 656 to cause the output tokens, generated by the language model 190, to be presented as synthesized speech. As another example, the action plan data 752 may include an identifier for the responding component 660 capable of generating outputs in more than one form (e.g., a multi-modal output component) to cause the tokens to be presented as synthesized speech, displayed text/graphics, and/or other types of outputs.

The (second) action plan data 752 may be sent (step 714) to the action plan execution component 625, and as described herein, the action plan execution component 625 may determine executable API calls based on the action plan data 752. If the action plan data 752 represents additional actions to be performed, then the action plan execution component 625 may cause the corresponding responding component(s) 660 to perform the additional action(s) and corresponding response(s) (e.g., API responses 762) may be communicated to the prompt generation component 180 (via the action plan execution component 625 and action plan response data 738) to initiate another iteration of processing by the language model 190 with respect to the user input data 115. If the action plan data 752 represents a response to be presented to the user 105, then the action plan execution component 625 may cause the corresponding responding component(s) 660 to determine output data (e.g., responsive output data 185 shown in FIG. 6) that may be presented via the user device 110. For example, the responsive output data 185 may be sent to the user device 110 via the orchestrator component 830 or another system component(s) 120 (described in relation to FIG. 8).

In some embodiments, when further actions are generated by the language model 190 to be performed with respect to the user input data 115, the language model orchestrator component 117 may perform another iteration of processing, which may involve generating another prompt 742 to the language model 190, generating another LM response 746 that may be used to determine further action plan data 752. The language model 190 may generate tokens corresponding to the action generation stage and/or the response generation stage during the further iteration.

In some embodiments, when a final response is generated by the language model 190, further processing with respect to the user input data 115 by the language model orchestrator component 117 may be ceased (e.g., processing with respect to the user input data 115 by the language model orchestrator component 117 may be complete). The language model orchestrator component 117 may process with respect to a subsequently received user input, which may or may not be part of the same dialog session as the prior/already processed user input data 115.

The responsive output data 185 may include one or more of output audio data representing synthesized speech, text data for display, image for display, graphics/icons for display, media (e.g., video, music, background music, notification sounds, etc.) for playback, and other data. In some embodiments, the responsive output data 185 may include placement information representing where (e.g., top banner, left portion, center of screen, overlay on current visual, etc.) on the display screen of the user device 110 the output data is to be displayed. In some embodiments, the responsive output data 185 may be determined/provided by the responding component 660. In some embodiments, another system component(s) 120 may process the responsive output data 185 prior to sending to the user device 110 to ensure that the responsive output data is formatted for the particular user device 110.

Referring again to FIG. 6, as shown, the system component(s) 120 may include a compliance component 670. In some embodiments, the compliance component 670 may be included in the language model orchestrator component 117. In other embodiments, the compliance component 670 may be one of the responding components 660 and the action plan generation component 650 may cause the action plan execution component 625 to send an API request to the compliance component 670 when processing by the compliance component 670 is to be performed.

The compliance component 670 may be configured to determine whether an output of the language model 190 is appropriate for output to the user 105. In some embodiments, the compliance component 670 may be configured to process language model output (e.g., the LM response 746) representing outputs/tokens generated by the language model 190 during processing of the user input data 115. The model output may include tokens generated during the task generation stage, the action generation stage or the response generation stage. The compliance component 670 may also or instead determine whether an input to the language model 190 (e.g., a user request, an output of another system component of the system 100) is appropriate and/or that the input will result in the language model 190 generating an output that is appropriate to present to the user 105. For this determination, the compliance component 670 may process the user input data 115 or a portion or representation thereof. In some embodiments, the compliance component 670 may process other data (e.g., context data, user profile data, system configuration/policy data, etc.) to determine whether the generated response and/or the input is appropriate.

In some embodiments, the compliance component 670 may determine whether the model output/LM response 746 and/or the user input data 115 corresponds to training data used to configure the language model 190 (e.g., the model output or user input is semantically or lexically similar to the training data, the model output or user input corresponds to functionality (e.g., topics, categories, actions, etc.) that the model is trained for, etc.). Additionally or alternatively, the compliance component 670 may determine whether the model output/LM response 746 and/or the user input data 115 corresponds to one or more words or phrases determined to be confidential, sensitive, or offensive. Additionally or alternatively, the compliance component 670 may determine whether the user input or the model output corresponds to an inappropriate content category, which may include biased content (e.g., biased toward protected classes including gender, race, age, etc.), harmful content (e.g., violent content, self-harm, etc.), profanity, etc.

In some embodiments, the compliance component 670 may use one or more techniques to determine whether the model output or the user input is appropriate; such techniques may include a rules-engine, a word-based similarity determination, a machine learning model based determination (e.g., using a classifier to classify model output or user input to appropriate category or inappropriate category), etc.

In some embodiments, the compliance component 670 may process the user input data 115 when it is received by the language model orchestrator component 117 and in some cases may process in parallel to the language model orchestrator component 117. In some embodiments, the compliance component 670 may process the model output as the language model 190 generates the output tokens. In other embodiments, the compliance component 670 may process the model output after the language model 190 has generated tokens for a particular processing stage (e.g., after the task generation stage is completed, after the action generation stage is completed, after the response generation stage is completed, etc.).

If the compliance component 670 determines that the model output or the user input data 115 is appropriate, then the language model orchestrator component 117 may continue processing with respect to the user input data 115. If the compliance component 670 determines that the model output is not appropriate, then one or more remedial actions may be performed. One example remedial action may involve prompting the language model 190 to generate a new/modified model output. In such examples, additional prompt data may be determined, which may include the original prompt data, the initial model output, and an indication that the initial model output is not appropriate for output to the user 105. The additional prompt data may include a request or directive to the language model 190 to generate model output that is appropriate for output to the user 105. Another example remedial action may involve the system outputting a generic/template response (e.g., “Sorry, I can't help you with that” or “I cannot answer questions for [inappropriate category])”) or a request for a rephrased input (e.g., “can you rephrase that”).

In some embodiments, the compliance component 670 may cause the system to output a response indicating where (e.g., a source external to the system component(s) 120) the included/outputted information may be found. For example, the response may include an indication of a source of the training data or the data (e.g., API response 762) that the response is based on (e.g., the indication may include a description of an owner of the intellectual property rights corresponding to the training data/the response information, a hyperlink to the source, etc.). In some embodiments the compliance component 670 may determine that the model generated response is based on (e.g., summarizing, using, similar to, etc.) data that protected by intellectual property rights (or other laws), and instead of outputting the language model generated response (e.g., LM response 746). In some embodiments the responsive output data 185 may include an indication of the intellectual property rights owner, may include access to a source of the data (e.g., website link), or may include a template response (e.g., “I cannot process this request” or “The requested data is protected by intellectual property rights”, etc.). In some embodiments, the compliance component 670 may determine that the user input data 115 involves processing data or outputting data that is protected by certain intellectual property rights (or other laws). An example of such a user input may be “write a story about [protected character]” or “draw an image of [protected character] doing [some action]”, where the owner of intellectual property rights in the [protected character] may not allow use, copying, or other operations. In response, the system may cease or prevent processing by the language model orchestrator component 117 of the user input data 115, and the system may output a template response (e.g., “I cannot process this request” or “The requested data is protected by intellectual property rights”, etc.).

As shown in FIG. 6, the system component(s) 120 may include a personalized context component 665. In some embodiments, the personalized context component 665 may be included in the language model orchestrator component 117. In other embodiments, the personalized context component 665 may be one of the responding components 660 and the action plan generation component 650 may cause the action plan execution component 625 to send an API request to the personalized context component 665.

The personalized context component 665 may be configured to determine personalized context data including context data corresponding to the user input data 115 and/or the user 105. In some embodiments, the initial plan generation component 635 may request personalized context data to include in the prompt 742. In other embodiments, other system component(s) 120, such as the language model 190, may request personalized context data (e.g., to determine a personalized response to a user input). The personalized context data may include user preferences, past user inputs, past system outputs for past user inputs from the user 105, past skill/app usage, user-defined items, etc. The personalized context component 665 may infer user preferences from user-provided preferences, past user interactions by the user 105, information related to users similar to the user 105, etc. In some embodiments, the personalized context component 665 may employ one or more techniques to determine the personalized context data; such techniques may include using a rules-engine, using one or more machine learning models (including a generative model), topic determination techniques, neural retrieval search techniques, etc.

In examples, the personalized context component 665 may receive the user input data 115, task data representing a current task being performed/processed, and/or model output indicating that an ambiguity exists or additional information is needed to generate a response to the user input. The personalized context component 665 may receive a query in some examples, which may include an identifier for the user 105. In a non-limiting example, the personalized context component 665 may receive the following example requests: “Does the user prefer to use [Music Service 1] or [Music Service 2] for playing music,” or “What kind of music does the user like?” The personalized context component 665 determine example personalized context data including “The user prefers [Music Service 1]” or “The user likes [music genre]”).

Further information related to the SSG component 656 and the skill/app component 654 is described herein in relation to FIG. 8.

In some embodiments, the language model 190 may be fine-tuned to perform a particular task(s). Fine-tuning of the language model(s) may be performed using one or more techniques. One example fine-tuning technique is transfer learning that involves reusing a pre-trained model's weights and architecture for a new task. The pre-trained model may be trained on a large, general dataset, and the transfer learning approach allows for efficient and effective adaptation to specific tasks. Another example fine-tuning technique is sequential fine-tuning where a pre-trained model is fine-tuned on multiple related tasks sequentially. This allows the model to learn more nuanced and complex language patterns across different tasks, leading to better generalization and performance. Yet another fine-tuning technique is task-specific fine-tuning where the pre-trained model is fine-tuned on a specific task using a task-specific dataset. Yet another fine-tuning technique is multi-task learning where the pre-trained model is fine-tuned on multiple tasks simultaneously. This approach enables the model to learn and leverage the shared representations across different tasks, leading to better generalization and performance. Yet another fine-tuning technique is adapter training that involves training lightweight modules that are plugged into the pre-trained model, allowing for fine-tuning on a specific task without affecting the original model's performance on other tasks. Some techniques may involve supervised fine-tuning (SFT), unsupervised fine-tuning, semi-supervised fine-tuning, or other types of learning.

In some embodiments, one or more of the system component(s) 120 described herein may be configured to begin processing with respect to data as soon as the data or a portion of the data is available to the components (e.g., processing in a streaming fashion). Some system components may be generative components/models that can begin processing with respect to portions of data as they are available, instead of waiting to initiate processing after the entirety of data is available. For example, the language model 190 may start processing a first portion of the prompt 742 while the prompt generation component 180 determines a second/subsequent portion of the prompt 742. As another example, the action plan generation component 650 may start processing a first portion of the LM response 746 while the language model 190 is generating a second/subsequent portion of the LM response 746.

The system 100 may operate using various components as described in FIG. 8. The various components may be located on same or different physical devices. Communication between various components may occur directly or across a network(s) 199. The user device 110 may include audio capture component(s), such as a microphone or array of microphones of a user device 110, captures audio 810 and creates corresponding audio data. Once speech is detected in audio data representing the audio 810, the user device 110 may determine if the speech is directed at the user device 110/system component(s). In at least some embodiments, such determination may be made using a wakeword detection component 820. The wakeword detection component 820 may be configured to detect various wakewords. In at least some examples, each wakeword may correspond to a name of a different digital assistant. An example wakeword/digital assistant name is “Alexa.” In another example, input to the system may be in form of text data 813, for example as a result of a user typing an input into a user interface of user device 110. Other input forms may include indication that the user has pressed a physical or virtual button on user device 110, the user has made a gesture, etc. The user device 110 may also capture images using camera(s) of the user device 110 and may send image data 821 representing those image(s) to the system component(s). The image data 821 may include raw image data or image data processed by the user device 110 before sending to the system component(s). The image data 821 may be used in various manners by different components of the system to perform operations such as determining whether a user is directing an utterance to the system, interpreting a user command, responding to a user command, etc. In some embodiments, the user input data 115 (described in relation to FIG. 6) may include one or more the audio 810, the audio data 811, the text data 813 and the image data 821.

The wakeword detection component 820 of the user device 110 may process the audio data, representing the audio 810, to determine whether speech is represented therein. The user device 110 may use various techniques to determine whether the audio data includes speech. In some examples, the user device 110 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the user device 110 may implement a classifier configured to distinguish speech from background noise. The classifier may be implemented by techniques such as linear classifiers, support vector machines, and decision trees. In still other examples, the user device 110 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 810, is analyzed to determine if specific characteristics of the audio data match preconfigured acoustic waveforms, audio signatures, or other data corresponding to a wakeword.

Thus, the wakeword detection component 820 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 820 may be built on deep neural network (DNN)/recursive neural network (RNN) structures directly, without HMM being involved. Such an architecture may estimate the posteriors of wakewords with context data, either by stacking frames within a context window for DNN, or using an RNN. Follow-on posterior threshold tuning or smoothing is applied for decision making. Other techniques for wakeword detection, such as those known in the art, may also be used.

Once the wakeword is detected by the wakeword detection component 820 and/or input is detected by an input detector, the user device 110 may “wake” and begin transmitting audio data 811, representing the audio 810, to the system component(s) 120. The audio data 811 may include data corresponding to the wakeword; in other embodiments, the portion of the audio corresponding to the wakeword is removed by the user device 110 prior to sending the audio data 811 to the system component(s) 120. In the case of touch input detection or gesture-based input detection, the audio data may not include a wakeword.

In some implementations, the system 100 may include more than one system component(s). The system component(s) 120 may respond to different wakewords and/or perform different categories of tasks. Each system component(s) may be associated with its own wakeword such that speaking a certain wakeword results in audio data be sent to and processed by a particular system. For example, detection of the wakeword “Alexa” by the wakeword detection component 820 may result in sending audio data to system component(s) 120a for processing while detection of the wakeword “Computer” by the wakeword detector may result in sending audio data to system component(s) 120b for processing. The system may have a separate wakeword and system for different skills/systems (e.g., “Castle Adventure” for a game play skill/system component(s) 120c) and/or such skills/systems may be coordinated by one or more skill component(s) 654 of one or more system component(s) 120.

The user device 110/system component(s) 120 may also include a system directed input detector 885. The system directed input detector 885 may be configured to determine whether an input to the system (for example speech, a gesture, etc.) is directed to the system or not directed to the system (for example directed to another user, etc.). The system directed input detector 885 may work in conjunction with the wakeword detection component 820. If the system directed input detector 885 determines an input is directed to the system, the user device 110 may “wake” and begin sending captured data for further processing. If data is being processed the user device 110 may indicate such to the user, for example by activating or changing the color of an illuminated output (such as a light emitting diode (LED) ring), displaying an indicator on a display (such as a light bar across the display), outputting an audio indicator (such as a beep) or otherwise informing a user that input data is being processed. If the system directed input detector 885 determines an input is not directed to the system (such as a speech or gesture directed to another user) the user device 110 may discard the data and take no further action for processing purposes. In this way the system 100 may prevent processing of data not directed to the system, thus protecting user privacy. As an indicator to the user, however, the system may output an audio, visual, or other indicator when the system directed input detector 885 is determining whether an input is potentially device directed. For example, the system may output an orange indicator while considering an input and may output a green indicator if a system directed input is detected. Other such configurations are possible.

Upon receipt by the system component(s) 120, the audio data 811 may be sent to an orchestrator component 830 and/or the language model orchestrator component 117. The orchestrator component 830 may include memory and logic that enables the orchestrator component 830 to transmit various pieces and forms of data to various components of the system, as well as perform other operations as described herein. In some embodiments, the orchestrator component 830 may optionally be included in the system component(s) 120. In embodiments where the orchestrator component 830 is not included in the system component(s) 120, the audio data 811 may be sent directly to the language model orchestrator component 117. Further, in such embodiments, each of the components of the system component(s) 120 may be configured to interact with the language model orchestrator component 117, the action plan execution component 625, the API provider component, and/or other component(s).

In some embodiments, the system component(s) 120 may include an arbitrator component 882, which may be configured to determine whether the orchestrator component 830 and/or the language model orchestrator component 117 are to process with respect to user input data. In some embodiments, the language model orchestrator component 117 may be selected to process with respect to the audio data 811 only if the user 105 associated with the audio data 811 (or the user device 110 that captured the audio 810) has previously indicated that the language model orchestrator component 117 may be selected to process with respect to user inputs received from the user 105.

In some embodiments, the arbitrator component 882 may determine the orchestrator component 830 and/or the language model orchestrator component 117 are to process with respect to the audio data 811 based on metadata associated with the audio data 811. For example, the arbitrator component 882 may be a classifier configured to process a natural language representation of the audio data 811 (e.g., output by the ASR component 130) and classify the corresponding user input as to be processed by the orchestrator component 830 and/or the language model orchestrator component 117. For further example, the arbitrator component 882 may determine whether the device from which the audio data 811 is received is associated with an indicator representing the audio data 811 is to be processed by the orchestrator component 830 and/or the language model orchestrator component 117. As an even further example, the arbitrator component 882 may determine whether the user (e.g., determined using data output from the user recognition component 895) from which the audio data 811 is received is associated with a user profile including an indicator representing the audio data 811 is to be processed by the orchestrator component 830 and/or the language model orchestrator component 117. As another example, the arbitrator component 882 may determine whether the audio data 811 (or the output of the ASR component 130) corresponds to a request representing that the audio data 811 is to be processed by the orchestrator component 830 and/or the language model orchestrator component 117 (e.g., a request including “let's chat” may represent that the audio data 811 is to be processed by the language model orchestrator component 117).

In some embodiments, if the arbitrator component 882 is unsure (e.g., a confidence score corresponding to whether the orchestrator component 830 and/or the language model orchestrator component 117 is to process is below a threshold), then the arbitrator component 882 may send the audio data 811 to both of the orchestrator component 830 and the language model orchestrator component 117. In such embodiments, the orchestrator component 830 and/or the language model orchestrator component 117 may include further logic for determining further confidence scores during processing representing whether the orchestrator component 830 and/or the language model orchestrator component 117 should continue processing, as is discussed further herein below.

The arbitrator component 882 may send the audio data 811 to an ASR component 130. In some embodiments, the component selected to process the audio data 811 (e.g., the orchestrator component 830 and/or the language model orchestrator component 117) may send the audio data 811 to the ASR component 130. The ASR component 130 may transcribe the audio data 811 into text data. The text data output by the ASR component 130 represents one or more than one (e.g., in the form of an N-best list) ASR hypotheses representing speech represented in the audio data 811. The ASR component 130 interprets the speech in the audio data 811 based on a similarity between the audio data 811 and pre-established language models. For example, the ASR component 130 may compare the audio data 811 with models for sounds (e.g., acoustic units such as phonemes, senons, phones, etc.) and sequences of sounds to identify words that match the sequence of sounds of the speech represented in the audio data 811. The ASR component 130 sends the text data generated thereby to the arbitrator component 882, the orchestrator component 830, and/or the language model orchestrator component 117. In instances where the text data is sent to the arbitrator component 882, the arbitrator component 882 may send the text data to the component selected to process the audio data 811 (e.g., the orchestrator component 830 and/or the language model orchestrator component 117). The text data sent from the ASR component 130 to the arbitrator component 882, the orchestrator component 830, and/or the language model orchestrator component 117 may include a single top-scoring ASR hypothesis or may include an N-best list including multiple top-scoring ASR hypotheses. An N-best list may additionally include a respective score associated with each ASR hypothesis represented therein.

In some embodiments, the orchestrator component 830 may cause a NLU component (not shown) to perform processing with respect to the ASR data generated by the ASR component 130. The NLU component may attempt to make a semantic interpretation of the phrase(s) or statement(s) represented in the ASR data input therein by determining one or more meanings associated with the phrase(s) or statement(s) represented in the text data. The NLU component may determine an intent representing an action that a user desires be performed and may determine information that allows a device (e.g., the device 110, the system component(s) 120, a skill/app component 654, a skill system component(s) 825, etc.) to execute the intent. For example, if the ASR data corresponds to “play the 5th Symphony by Beethoven,” the NLU component may determine an intent that the system output music and may identify “Beethoven” as an artist/composer and “5th Symphony” as the piece of music to be played. For further example, if the ASR data corresponds to “what is the weather,” the NLU component may determine an intent that the system output weather information associated with a geographic location of the device 110. In another example, if the ASR data corresponds to “turn off the lights,” the NLU component may determine an intent that the system turn off lights associated with the device 110 or the user 105. However, if the NLU component is unable to resolve the entity—for example, because the entity is referred to by anaphora such as “this song” or “my next appointment” the system can send a decode request to another speech processing system for information regarding the entity mention and/or other context related to the utterance. The natural language processing system may augment, correct, or base results data upon the ASR data as well as any data received from the system.

The NLU component may return NLU results data (which may include tagged text data, indicators of intent, etc.) back to the orchestrator component 830. The orchestrator component 830 may forward the NLU results data to a skill component(s) 654. If the NLU results data includes a single NLU hypothesis, the NLU component and the orchestrator component 830 may direct the NLU results data to the skill component(s) 654 associated with the NLU hypothesis. If the NLU results data includes an N-best list of NLU hypotheses, the NLU component and the orchestrator component 830 may direct the top scoring NLU hypothesis to a skill component(s) 654 associated with the top scoring NLU hypothesis. The system may also include a post-NLU ranker which may incorporate other information to rank potential interpretations determined by the NLU component.

In some embodiments, after determining that the orchestrator component 830 and/or the language model orchestrator component 117 should process with respect to the user input, the arbitrator component 882 may be configured to periodically determine whether the orchestrator component 830 and/or the language model orchestrator component 117 should continue processing with respect to the user input. For example, after a particular point in the processing of the orchestrator component 830 (e.g., after performing NLU, prior to determining a skill component 654 to process with respect to the user input, prior to performing an action responsive to the user input, etc.) and/or the language model orchestrator component 117 (e.g., after selecting a task to be completed, after receiving the action response data from the one or more components, after completing a task, prior to performing an action responsive to the user input, etc.) the orchestrator component 830 and/or the language model orchestrator component 117 may query the arbitrator component 882 has determined that the orchestrator component 830 and/or the language model orchestrator component 117 should halt processing with respect to the user input. As discussed above, the system 100 may be configured to stream portions of data associated with processing with respect to a user input to the one or more components such that the one or more components may begin performing their configured processing with respect to that data as soon as it is available to the one or more components. As such, the arbitrator component 882 may cause the orchestrator component 830 and/or the language model orchestrator component 117 to begin processing with respect to a user input as soon as a portion of data associated with the user input is available (e.g., the ASR data, context data, output of the user recognition component 895. Thereafter, once the arbitrator component 882 has enough data to perform the processing described herein above to determine whether the orchestrator component 830 and/or the language model orchestrator component 117 is to process with respect to the user input, the arbitrator component 882 may inform the corresponding component (e.g., the orchestrator component 830 and/or the language model orchestrator component 117) to continue/halt processing with respect to the user input at one of the logical checkpoints in the processing of the orchestrator component 830 and/or the language model orchestrator component 117.

A skill system component(s) 825 may communicate with a skill/app component(s) 654 within the system component(s) 120 directly with the orchestrator component 830 and/or the action plan execution component 625, or with other components. A skill system component(s) 825 may be configured to perform one or more actions. An ability to perform such action(s) may sometimes be referred to as a “skill.” That is, a skill may enable a skill system component(s) 825 to execute specific functionality in order to provide data or perform some other action requested by a user. For example, a weather service skill may enable a skill system component(s) 825 to provide weather information to the system component(s) 120, a car service skill may enable a skill system component(s) 825 to book a trip with respect to a taxi or ride sharing service, an order pizza skill may enable a skill system component(s) 825 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system component(s) 120 may be configured with a skill/app component 654 dedicated to interacting with the skill system component(s) 825. Unless expressly stated otherwise, reference to a skill, skill device, or skill component may include a skill/app component 654 operated by the system component(s) 120 and/or skill/app operated by the skill system component(s) 825. Moreover, the functionality described herein as a skill or skill may be referred to using many different terms, such as an action, bot, app, or the like. The skill component 654 and or skill system component(s) 825 may return output data to the orchestrator component 830.

The system component(s) includes a SSG component 656. The SSG component 656 may generate audio data (e.g., synthesized speech) from text data, text embeddings, text tokens, audio tokens, audio embeddings, etc., using one or more different methods. Data input to the SSG component 656 may come from a skill/app component 654, the orchestrator component 830, the action plan execution component 625, or another component of the system. In one method of synthesis called unit selection, the SSG component 656 matches data against a database of recorded speech. The SSG component 656 selects matching units of recorded speech and concatenates the units together to form audio data. In another method of synthesis called parametric synthesis, the SSG component 656 varies parameters such as frequency, volume, and noise to create audio data including an artificial speech waveform. Parametric synthesis uses a computerized voice generator, sometimes called a vocoder.

The user device 110 may include still image and/or video capture components such as a camera or cameras to capture one or more images. The user device 110 may include circuitry for digitizing the images and/or video for transmission to the system component(s) 120 as image data. The user device 110 may further include circuitry for voice command-based control of the camera, allowing a user 105 to request capture of image or video data. The user device 110 may process the commands locally or send audio data 811 representing the commands to the system component(s) 120 for processing, after which the system component(s) 120 may return output data that can cause the user device 110 to engage its camera.

The system component(s) 120/the user device 110 may include a user recognition component 895 that recognizes one or more users using a variety of data. However, the disclosure is not limited thereto, and the user device 110 may include the user recognition component 895 instead of and/or in addition to the system component(s) 120 without departing from the disclosure.

The user recognition component 895 may take as input the audio data 811 and/or text data output by the ASR component 130. The user recognition component 895 may perform user recognition by comparing audio characteristics in the audio data 811 to stored audio characteristics of users. The user recognition component 895 may also perform user recognition by comparing biometric data (e.g., fingerprint data, iris data, etc.), received by the system in correlation with the present user input, to stored biometric data of users assuming user permission and previous authorization. The user recognition component 895 may further perform user recognition by comparing image data (e.g., including a representation of at least a feature of a user), received by the system in correlation with the present user input, with stored image data including representations of features of different users. The user recognition component 895 may perform additional user recognition processes, including those known in the art.

The user recognition component 895 determines scores indicating whether user input originated from a particular user. For example, a first score may indicate a likelihood that the user input originated from a first user, a second score may indicate a likelihood that the user input originated from a second user, etc. The user recognition component 895 also determines an overall confidence regarding the accuracy of user recognition operations.

Output of the user recognition component 895 may include a single user identifier corresponding to the most likely user that originated the user input. Alternatively, output of the user recognition component 895 may include an N-best list of user identifiers with respective scores indicating likelihoods of respective users originating the user input. The output of the user recognition component 895 may be used to inform processing of the arbitrator component 882, the orchestrator component 830, and/or the language model orchestrator component 117 as well as processing performed by other components of the system.

The system component(s) 120/user device 110 may include a presence detection component that determines the presence and/or location of one or more users using a variety of data.

The system 100 (either on user device 110, system component(s), or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc. ; input and output capabilities of the device; internet connectivity information; user bibliographic information; subscription information, as well as other information.

The profile storage 870 may include one or more user profiles, with each user profile being associated with a different user identifier/user profile identifier. Each user profile may include various user identifying data. Each user profile may also include data corresponding to preferences of the user. Each user profile may also include preferences of the user and/or one or more device identifiers, representing one or more devices of the user. For instance, the user account may include one or more internet protocol (IP) addresses, medium access control (MAC) addresses, and/or device identifiers, such as a serial number, of each additional electronic device associated with the identified user account. When a user logs into to an application installed on a user device 110, the user profile (associated with the presented login information) may be updated to include information about the user device 110, for example with an indication that the device is currently in use. Each user profile may include identifiers of components (e.g., responding component(s) 660 such as skills/apps, language model-based agents, knowledge bases, components for a particular domain, etc.) that the user has enabled. When a user enables a component, the user is providing the system component(s) with permission to allow the component to execute with respect to the user's inputs. If a user does not enable a component, the system component(s) may not invoke that component to execute with respect to the user's inputs.

The profile storage 870 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 870 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

Although the components of FIG. 8 may be illustrated as part of system component(s) 120, user device 110, or otherwise, the components may be arranged in other device(s) (such as in user device 110 if illustrated in system component(s) 120 or vice-versa, or in other device(s) altogether) without departing from the disclosure.

In at least some embodiments, the system component(s) 120 may receive the audio data 811 from the user device 110, to recognize speech corresponding to a spoken input in the received audio data 811, and to perform functions in response to the recognized speech. In at least some embodiments, these functions involve sending directives (e.g., commands), from the system component(s) to the user device 110 (and/or other user devices 110) to cause the user device 110 to perform an action, such as output an audible response to the spoken input via a loudspeaker(s), and/or control secondary devices in the environment by sending a control command to the secondary devices.

Thus, when the user device 110 is able to communicate with the system component(s) over the network(s) 199, some or all of the functions capable of being performed by the system component(s) may be performed by sending one or more directives over the network(s) 199 to the user device 110, which, in turn, may process the directive(s) and perform one or more corresponding actions. For example, the system component(s), using a remote directive that is included in response data (e.g., a remote response), may direct the user device 110 to output an audible response (e.g., using SSG processing performed by an on-device SSG component) to a user's question via a loudspeaker(s) of (or otherwise associated with) the user device 110, to output content (e.g., music) via the loudspeaker(s) of (or otherwise associated with) the user device 110, to display content on a display of (or otherwise associated with) the user device 110, and/or to send a directive to a secondary device (e.g., a directive to turn on a smart light). It is to be appreciated that the system component(s) may be configured to provide other functions in addition to those discussed herein, such as, without limitation, providing step-by-step directions for navigating from an origin location to a destination location, conducting an electronic commerce transaction on behalf of the user 105 as part of a shopping function, establishing a communication session (e.g., a video call) between the user 105 and another user, and so on.

In at least some embodiments, the user device 110, may send the audio data 811 to the wakeword detection component 820. If the wakeword detection component 820 detects a wakeword in the audio data 811, the wakeword detection component 820 may send an indication of such detection to the user device 110. In response to receiving the indication, the audio data 811 may be sent to the system component(s) 120 and/or the ASR component of the user device 110. The wakeword detection component 820 may also send an indication, to the user device 110, representing a wakeword was not detected. In response to receiving such an indication, the audio data 811 may not be sent to the system component(s) 120, and the user device 110 may prevent the ASR component of the user device 110 from further processing the audio data 811. In this situation, the audio data 811 can be discarded.

In some embodiments, the user device 110 may include some or all of the components illustrated in FIG. 8 and/or discussed herein above with respect to the system component(s) 120. In other embodiments, the components illustrated in FIG. 8 and/or discussed herein with respect to the system component(s) 120 may be distributed across the user device 110 and the system component(s) 120.

In at least some embodiments, the components of the user device 110 (e.g., on-device components) may not have the same capabilities as the components of the system component(s) 120. For example, on-device components may be configured to generate a response to only a subset of the natural language user inputs that may be handled by the system component(s) 120. For example, such subset of natural language user inputs may correspond to local-type natural language user inputs, such as those controlling devices or components associated with a user's home. In such circumstances the on-device components may be able to more quickly interpret and respond to a local-type natural language user input, for example, than processing that involves the system component(s). If the user device 110 attempts to process a natural language user input for which the on-device components are not necessarily best suited, the language processing results determined by the user device 110 may indicate a low confidence or other metric indicating that the processing by the user device 110 may not be as accurate as the processing done by the system component(s) 120.

In some embodiments, the system component(s) 120 and the user device 110 may process as described herein to generate responses to the user input corresponding to the audio data 811. The system component(s) 120 may send the response to the user device 110 and the user device 110 may determine whether to output the response generated by the system component(s) 120 or the response generated by the user device 110. In some embodiments, the system component(s) 120 may be configured to perform a portion of the processing described herein, such as a portion of processing not performable by the user device 110 and send the result of such processing to the user device 110. The user device 110 may be configured to determine whether to use the result to complete processing to generate the response to the user device 110.

In at least some embodiments, the user device 110 may include, or be configured to use, one or more skill/app components that may operate similarly to the skill/app component(s) 654. The skill/app component(s) on the user device 110 may correspond to one or more domains that are used in order to determine how to act on a spoken input in a particular way, such as by outputting a directive that corresponds to the determined intent, and which can be processed to implement the desired operation. The skill component(s) installed on the user device 110 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally, or alternatively, the user device 110 may be in communication with one or more skill system component(s) 825. For example, a skill system component(s) 825 may be located in a remote environment (e.g., separate location) such that the user device 110 may only communicate with the skill system component(s) 825 via the network(s) 199. However, the disclosure is not limited thereto. For example, in at least some embodiments, a skill system component(s) 825 may be configured in a local environment (e.g., home server and/or the like) such that the user device 110 may communicate with the skill system component(s) 825 via a private network, such as a local area network (LAN).

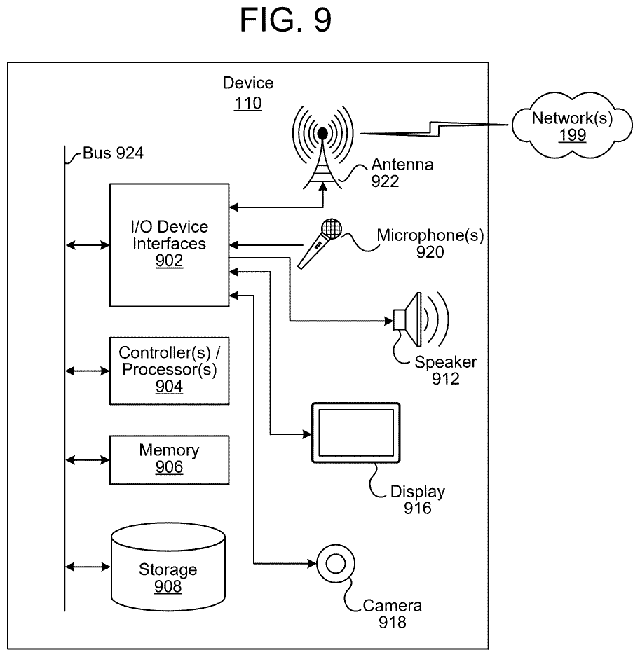

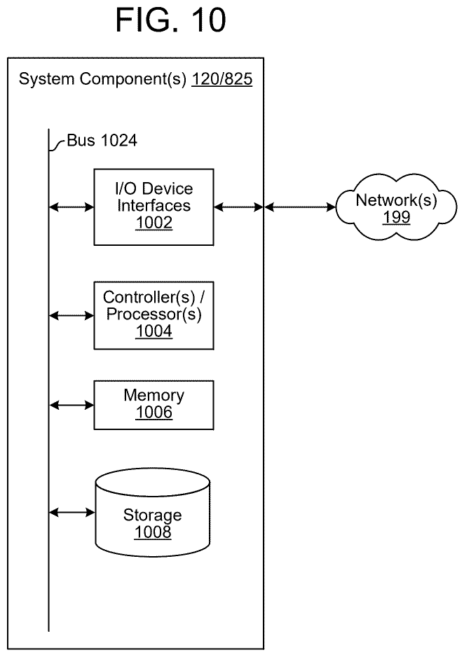

FIG. 9 is a block diagram conceptually illustrating a user device 110 that may be used with the system. FIG. 10 is a block diagram conceptually illustrating example components of a remote device, such as the system component(s) 120, which may assist with ASR processing, NLU processing, language model processing, etc., and a skill system component(s) 825. System component(s) (120/825) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the user device 110 may operate locally to a user (e.g., within a same environment so the device may receive inputs and playback outputs for the user) the server/system component(s) may be located remotely from the user device 110 as its operations may not require proximity to the user. The server/system component(s) may be located in an entirely different location from the user device 110 (for example, as part of a cloud computing system or the like) or may be located in a same environment as the user device 110 but physically separated therefrom (for example a home server or similar device that resides in a user's home or business but perhaps in a closet, basement, attic, or the like). The system component(s) 120 may also be a version of a user device 110 that includes different (e.g., more) processing capabilities than other user device(s) 110 in a home/office. One benefit to the server/system component(s) being in a user's home/business is that data used to process a command/return a response may be kept within the user's home, thus reducing potential privacy concerns.

Multiple system components (120/825) may be included in the system 100 of the present disclosure, such as one or more natural language processing system component(s) 120 for performing ASR processing, one or more natural language processing system component(s) 120 for performing NLU processing, one or more skill system component(s) 825, etc. In operation, each of these systems may include computer-readable and computer-executable instructions that reside on the respective device (120/825), as will be discussed further below.

Each of these devices (110/120/825) may include one or more controllers/processors (904/1004), which may each include a central processing unit (CPU) for processing data and computer-readable instructions, and a memory (906/1006) for storing data and instructions of the respective device. The memories (906/1006) may individually include volatile random-access memory (RAM), non-volatile read only memory (ROM), non-volatile magnetoresistive memory (MRAM), and/or other types of memory. Each device (110/120/825) may also include a data storage component (908/1008) for storing data and controller/processor-executable instructions. Each data storage component (908/1008) may individually include one or more non-volatile storage types such as magnetic storage, optical storage, solid-state storage, etc. Each device (110/120/825) may also be connected to removable or external non-volatile memory and/or storage (such as a removable memory card, memory key drive, networked storage, etc.) through respective input/output device interfaces (902/1002).

Computer instructions for operating each device (110/120/825) and its various components may be executed by the respective device's controller(s)/processor(s) (904/1004), using the memory (906/1006) as temporary “working” storage at runtime. A device's computer instructions may be stored in a non-transitory manner in non-volatile memory (906/1006), storage (908/1008), or an external device(s). Alternatively, some or all of the executable instructions may be embedded in hardware or firmware on the respective device in addition to or instead of software.

Each device (110/120/825) includes input/output device interfaces (902/1002). A variety of components may be connected through the input/output device interfaces (902/1002), as will be discussed further below. Additionally, each device (110/120/825) may include an address/data bus (924/1024) for conveying data among components of the respective device. Each component within a device (110/120/825) may also be directly connected to other components in addition to (or instead of) being connected to other components across the bus (924/1024).

Referring to FIG. 9, the user device 110 may include input/output device interfaces 902 that connect to a variety of components such as an audio output component such as a speaker 912, a wired headset or a wireless headset (not illustrated), or other component capable of outputting audio. The user device 110 may also include an audio capture component. The audio capture component may be, for example, a microphone 920 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 110 may additionally include a display 916 for displaying content. The user device 110 may further include a camera 918.

Via antenna(s) 922, the input/output device interfaces 902 may connect to a network(s) 199 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (902/1002) may also include communication components that allow data to be exchanged between devices such as different physical servers in a collection of servers or other components.

The components of the user device(s) 110, the system component(s) 120, or a skill system component(s) 825 may include their own dedicated processors, memory, and/or storage. Alternatively, one or more of the components of the user device(s) 110, the system component(s) 120, or a skill system component(s) 825 may utilize the I/O interfaces (902/1002), processor(s) (904/1004), memory (906/1006), and/or storage (908/1008) of the user device(s) 110, the system component(s) 120, or the skill system component(s) 825, respectively. Thus, the ASR component 130 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the user device 110, the system component(s) 120, and a skill system component(s) 825, as described herein, are illustrative, and may be located as a stand-alone device or may be included, in whole or in part, as a component of a larger device or system. As can be appreciated, a number of components may exist either as a system component(s) and/or on user device 110. Unless expressly noted otherwise, the system version of such components may operate similarly to the user device version of such components and thus the description of one version (e.g., the system version or the local user device version) applies to the description of the other version (e.g., the local user device version or system version) and vice-versa.

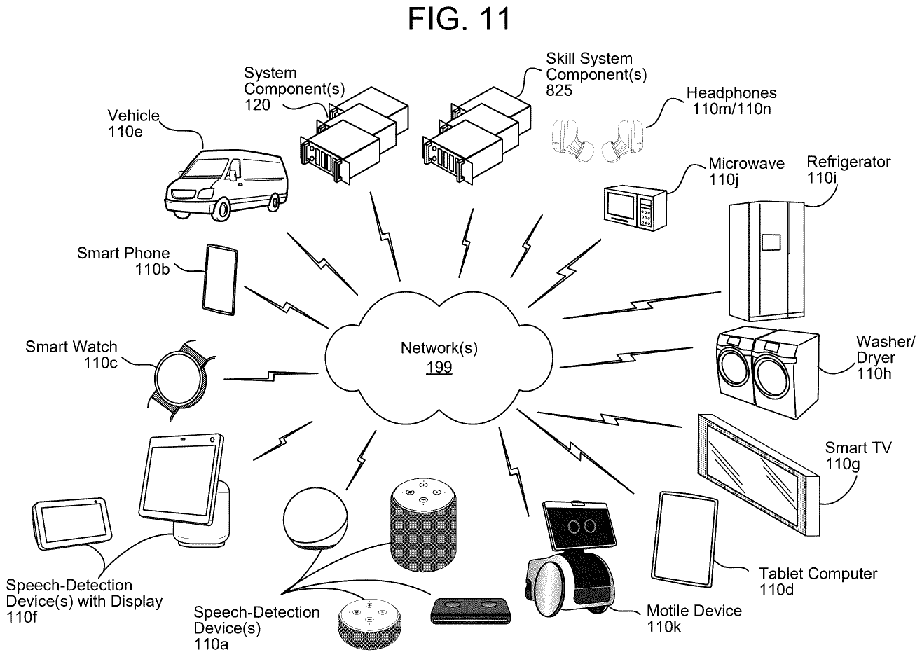

As illustrated in FIG. 11, multiple devices (110a-110n, 120, 825) may contain components of the system and the devices may be connected over a network(s) 199. The network(s) 199 may include a local or private network or may include a wide network such as the Internet. Devices may be connected to the network(s) 199 through either wired or wireless connections. For example, a speech-detection user device 110a, a smart phone 110b, a smart watch 110c, a tablet computer 110d, a vehicle 110e, a speech-detection device with display 110f, a display/smart television 110g, a washer/dryer 110h, a refrigerator 110i, a microwave 110j, autonomously motile user device 110k (e.g., a robot), headphones 110m/110n (e.g., wireless earbuds, wireless headphones), etc., may be connected to the network(s) 199 through a wireless service provider, over a Wi-Fi or cellular network connection, or the like. Other devices are included as network-connected support devices, such as the system component(s) 120, the skill system component(s) 825, and/or others. The support devices may connect to the network(s) 199 through a wired connection or wireless connection. Networked devices may capture audio using one-or-more built-in or connected microphones or other audio capture devices, with processing performed by components of the same device or another device connected via the network(s) 199, such as the system component(s) 120.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

As used herein and in the appended claims, the term “computer-readable media” refers to one or more mediums or devices that store or transmit information in a format that a computer system accesses. Computer-readable media encompasses both storage media and transmission media. Storage media includes volatile and non-volatile memory devices such as RAM devices, ROM devices, secondary storage devices, register memory devices, memory controller devices, graphics memory devices, and the like. Transmission media includes wired and wireless physical pathways that carry communication signals such as twisted pair cable, coaxial cable, fiber optic cable, radio waves, microwaves, infrared, visible light communication, and the like.

As used herein and in the appended claims, the term “non-transitory computer-readable media” encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations. For example, “a processor configured to carry out recitations A, B and C” encompasses both (a) a single processor configured to carry out recitations A, B, and C and (b) a first processor configured to carry out recitation A working in conjunction with a second processor configured to carry out recitations B and C.

Unless otherwise clear in context, the terms “set,” and “collection” should generally be interpreted to include one or more described items throughout this application. Accordingly, unless otherwise clear in context, phrases such as “a set of devices configured to” or “a collection of devices configured to” are intended to include one or more recited devices. Such one or more recited devices, unless otherwise clear in context, are collectively configured to carry out the stated recitations. For example, “a set of servers configured to carry out recitations A, B and C” encompasses both (a) a single server configured to carry out recitations A, B, and C and (b) a first server configured to carry out recitations A and B working in conjunction with a second server configured to carry out recitation C.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Unless the context clearly indicates otherwise, the relational term “in response to” or “responsive to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Further, the phrase “based on” is intended to mean “based at least in part on” unless specifically stated otherwise.

What is claimed is:

1. A computer-implemented method comprising:
receiving, from a first user device, input audio data including a spoken natural language input;
generating text data corresponding to a transcription of the spoken natural language input;
generating, using the text data, first embedding data corresponding to a semantic representation of the spoken natural language input;
determining a user identifier associated with the input audio data;
determining second embedding data associated with the user identifier, wherein the second embedding data corresponds to a semantic representation of a summary of a user-system dialog that was performed using a second user device;
determining a value representing a semantic similarity between the first embedding data and the second embedding data;
determining the value satisfies a threshold value;
based on the value satisfying the threshold value, generating prompt data including:
a first portion corresponding to the text data; and
a second portion corresponding to the user-system dialog;
processing, using a language model, the prompt data to determine a response to the spoken natural language input, wherein the language model uses the user-system dialog as context for processing the text data; and
causing presentation of the response.

2. The computer-implemented method of claim 1, further comprising:
receiving second text data corresponding to a second spoken natural language input;
receiving third text data corresponding to a system-generated response to the second spoken natural language input;
generating fourth text data by concatenating the second text data and the third text data;
generating third embedding data corresponding to a semantic representation of the fourth text data;
receiving fifth text data corresponding to a third spoken natural language input;
receiving sixth text data corresponding to a system-generated response to the third spoken natural language input;
generating seventh text data by concatenating the fifth text data and the sixth text data;
generating fourth embedding data corresponding to a semantic representation of the seventh text data;
determining a second value representing a semantic similarity between the third embedding data and the fourth embedding data;
determining the second value satisfies the threshold value;
based on the second value satisfying the threshold value, processing, using the language model, the second text data, the third text data, the fifth text data, and the sixth text data to determine eighth text data corresponding to a summary of the second spoken natural language input, the system-generated response to the second spoken natural language input, the third spoken natural language input, and the system-generated response to the third spoken natural language input;
generating the second embedding data using the eighth text data; and
storing the second embedding data in association with the user identifier prior to receiving the input audio data.

3. The computer-implemented method of claim 1, further comprising, based on the value satisfying the threshold value:
processing, using the language model, the text data, second text data corresponding to the response, and third text data corresponding to the summary of the user-system dialog to determine fourth text data corresponding to an updated summary of the user-system dialog;
determining third embedding data corresponding to a semantic representation of the updated summary; and
storing the third embedding data in association with the user identifier.

4. The computer-implemented method of claim 1, further comprising:
processing, using the language model, usage history data to determine a first number of topics in the usage history data;
processing, using a semantic similarity component, the usage history data to determine a second number of topics in the usage history data; and
determining the threshold value by minimizing a loss of the semantic similarity component based on the first number of topics and the second number of topics.

5. A computer-implemented method comprising:
receiving input data corresponding to a user input;
generating, using the input data, first embedding data corresponding to a semantic representation of the user input;
determining second embedding data corresponding to a semantic representation of a user-system dialog;
determining a value representing a semantic similarity between the first embedding data and the second embedding data;
based on the value, processing, using a generative model, the user input and the user-system dialog to determine a response to the user input, wherein the generative model uses the user-system dialog as context for processing the user input; and
causing presentation of the response.

6. The computer-implemented method of claim 5, further comprising:
receiving second input data corresponding to a second user input;
receiving first output data corresponding to a system-generated response to the second user input;
generating, using the second input data and the first output data, third embedding data corresponding to a semantic representation of the second user input and the system-generated response to the second user input;
receiving third input data corresponding to a third user input;
receiving second output data corresponding to a system-generated response to the third user input;
generating, using the third input data and the second output data, fourth embedding data corresponding to a semantic representation of the third user input and the system-generated response to the third user input;
determining a second value representing a semantic similarity between the third embedding data and the fourth embedding data;
based on the second value, determining summary data including a summary of the second user input, the system-generated response to the second user input, the third user input, and the system-generated response to the third user input; and
generating the second embedding data using the summary data.

7. The computer-implemented method of claim 6, further comprising, prior to receiving the input data, storing the second embedding data in association with a user identifier associated with the input data.

8. The computer-implemented method of claim 5, further comprising, based on the value:
processing, using the generative model, the input data, output data corresponding to the response, and summary data corresponding to a summary of the user-system dialog to determine updated summary data corresponding to an updated summary of the user-system dialog;
determining, using the updated summary data, third embedding data corresponding to a semantic representation of the updated summary; and
storing the third embedding data in association with a user identifier associated with the input data.

9. The computer-implemented method of claim 5, further comprising:
processing, using the generative model, usage history data to determine a first number of topics in the usage history data;
processing, using a semantic similarity component, the usage history data to determine a second number of topics in the usage history data; and
determining a threshold semantic similarity value by minimizing a loss of the semantic similarity component based on the first number of topics and the second number of topics,
wherein determining the response to the user input is based on the value satisfying the threshold semantic similarity value.

10. The computer-implemented method of claim 5, further comprising:
receiving second input data corresponding to a second user input;
generating, using the input data, third embedding data corresponding to a semantic representation of the second user input;
determining the third embedding data is semantically similar to:
fourth embedding data corresponding to a semantic representation of a second user-system dialog; and
fifth embedding data corresponding to a semantic representation of a third user-system dialog;
causing presentation of a request for a third user input selecting one of the second user-system dialog and the third user-system dialog;
receiving third input data selecting the second user-system dialog;
based on the third input data, processing, using the generative model, the second user input and the second user-system dialog to determine a response to the second user input, wherein the generative model uses the second user-system dialog as context for processing the second user input; and
causing presentation of the response to the second user input.

11. The computer-implemented method of claim 5, further comprising:
determining a summary of the user-system dialog; and
determining the second embedding data to correspond to a semantic representation of the summary.

12. The computer-implemented method of claim 5, further comprising:
determining a user identifier or a group identifier associated with the input data; and
determining second embedding data is associated with the user identifier or the group identifier.

13. A system comprising:
at least one processor; and
at least one memory including instructions that, when executed by the at least one processor, cause the system to:
receive input data corresponding to a user input;
generate, using the input data, first embedding data corresponding to a semantic representation of the user input;
determine second embedding data corresponding to a semantic representation of a user-system dialog;
determine a value representing a semantic similarity between the first embedding data and the second embedding data;
based on the value, process, using a generative model, the user input and the user-system dialog to determine a response to the user input, wherein the generative model uses the user-system dialog as context for processing the user input; and
cause presentation of the response.

14. The system of claim 13, wherein the at least one memory includes further instructions that, when executed by the at least one processor, cause the system to:
receive second input data corresponding to a second user input;
receive first output data corresponding to a system-generated response to the second user input;
generate, using the second input data and the first output data, third embedding data corresponding to a semantic representation of the second user input and the system-generated response to the second user input;
receive third input data corresponding to a third user input;
receive second output data corresponding to a system-generated response to the third user input;
generate, using the third input data and the second output data, fourth embedding data corresponding to a semantic representation of the third user input and the system-generated response to the third user input;
determine a second value representing a semantic similarity between the third embedding data and the fourth embedding data;
based on the second value, determine summary data including a summary of the second user input, the system-generated response to the second user input, the third user input, and the system-generated response to the third user input; and
generate the second embedding data using the summary data.

15. The system of claim 14, wherein the at least one memory includes further instructions that, when executed by the at least one processor, cause the system to, prior to receiving the input data, storing the second embedding data in association with a user identifier associated with the input data.

16. The system of claim 13, wherein the at least one memory includes further instructions that, when executed by the at least one processor, cause the system to, based on the value:
process, using the generative model, the input data, output data corresponding to the response, and summary data corresponding to a summary of the user-system dialog to determine updated summary data corresponding to an updated summary of the user-system dialog;
determine, using the updated summary data, third embedding data corresponding to a semantic representation of the updated summary; and
store the third embedding data in association with a user identifier associated with the input data.

17. The system of claim 13, wherein the at least one memory includes further instructions that, when executed by the at least one processor, cause the system to:
process, using the generative model, usage history data to determine a first number of topics in the usage history data;
process, using a semantic similarity component, the usage history data to determine a second number of topics in the usage history data; and
determine a threshold semantic similarity value by minimizing a loss of the semantic similarity component based on the first number of topics and the second number of topics,
wherein determining the response to the user input is based on the value satisfying the threshold semantic similarity value.

18. The system of claim 13, wherein the at least one memory includes further instructions that, when executed by the at least one processor, cause the system to:
receive second input data corresponding to a second user input;
generate, using the input data, third embedding data corresponding to a semantic representation of the second user input;
determine the third embedding data is semantically similar to:
fourth embedding data corresponding to a semantic representation of a second user-system dialog; and
fifth embedding data corresponding to a semantic representation of a third user-system dialog;
cause presentation of a request for a third user input selecting one of the second user-system dialog and the third user-system dialog;
receive third input data selecting the second user-system dialog;
based on the third input data, process, using the generative model, the second user input and the second user-system dialog to determine a response to the second user input, wherein the generative model uses the second user-system dialog as context for processing the second user input; and
cause presentation of the response to the second user input.

19. The system of claim 13, wherein the at least one memory includes further instructions that, when executed by the at least one processor, cause the system to:
determine a summary of the user-system dialog; and
determine the second embedding data to correspond to a semantic representation of the summary.

20. The system of claim 13, wherein the at least one memory includes further instructions that, when executed by the at least one processor, cause the system to:
determine a user identifier or a group identifier associated with the input data; and
determine second embedding data is associated with the user identifier or the group identifier.
